(19) United States
(12) Patent Application Publication
(10) Pub. No.: US 2012/0151391 A1
(43) Pub. Date: Jun. 14, 2012

(54) SYSTEMS AND METHODS FOR ORGANIZING MEDIA

(76) Inventors: Tejpaul Bhatia, New York, NY (US); Vikash Mishra, Denver, CO (US)

(21) Appl. No.: 13/316,216

(22) Filed: Dec. 9, 2011

Related U.S. Application Data
(60) Provisional application No. 61/422,295, filed on Dec. 13, 2010.

(51) Int. Cl. G06F 3/048; G06F 9/44

(52) U.S. Cl. 715/764; 719/328

(57) ABSTRACT

A system and method for organizing media across a plurality of websites is provided. The system includes a memory, at least one processor in data communication with the memory, and an index component executed by the at least one processor. The index component is configured to receive a set of authentication credentials, execute a plurality of API calls to a plurality of websites, receive a set of media information, and store a plurality of point representations within the memory.

### RELATED APPLICATIONS

This application claims priority under 35 U.S.C. §119(e) to U.S. Provisional Application Ser. No. 61/422,295, entitled “SYSTEM AND METHODOLOGY FOR INDEXING AND NORMALIZING MEDIA ASSETS ACROSS MULTIPLE SOCIAL NETWORKS,” filed on Dec. 13, 2010, which is hereby incorporated herein by reference in its entirety.

### BACKGROUND

1. Technical Field

The technical field relates generally to data and media management and, more particularly, to organizing media stored within one or more websites.

2. Background Discussion

The Internet has made keeping in touch with friends and acquaintances more convenient and easy. The Internet has also provided social forums for networking and meeting new people. For many people, the Internet represents the principal way in which to meet new friends and maintain existing friendships. Thus the Internet provides the forum for a complex array of interactions between vast numbers of individuals.

To facilitate communications between the vast numbers of individuals, various social networking websites have emerged. Many social networking websites provide organizational tools and forums that facilitate these individuals' interactions with one another via the social networking website. Some social networking websites have created systems and methods for generating a social timeline within a social network that enables people to maintain, create, and manage relationships with one another. Other platforms have created search mechanisms that allow people to locate data related to particular people, events, or issues. In many of these cases, users may limit communications to hand-selected groups of other users.

### SUMMARY

Aspects and embodiments disclosed herein manifest an appreciation that while websites, including disparate and discrete social networking websites and other platforms, have made it easier to search and store data within individual and isolated networks or platforms, barriers between these websites have hindered the compilation of even more succinct and efficient stores of data. Thus some embodiments include apparatus and processes that perform a method which links these websites to allow for data to be easily and comprehensively discovered and aggregated. Other embodiments include apparatus and processes that perform a method that identifies past social events and milestones from discovered data stored within these websites.

According to at least one embodiment, a system for organizing media across a plurality of websites is provided. The system includes a memory, at least one processor in data communication with the memory, and an index component executed by the at least one to processor. The index component is configured to receive a set of authentication credentials, each member of the set of authentication credentials corresponding to a respective website of the plurality of websites; execute a plurality of application program interface (API) calls, each API call of the plurality of API calls corresponding to a respective website of the plurality of websites, at least one API call of the plurality of API calls using a member of the set of authentication credentials; receive a set of media information from at least one of the plurality of websites, each member of the set of media information corresponding to a respective piece of media of a plurality of pieces of media; and store a plurality of point representations within the memory, each of the plurality of point representations corresponding to, and associated with, a respective piece of media of the plurality of pieces of media.

In the system, some of the plurality of API calls may correspond to at least one of Facebook, Twitter, Google, Foursquare, and Flickr, and the plurality of pieces of media may include at least one of a photograph, a video, and text data.

Within specific embodiments, the index component may be further configured to perform a variety of functions. For instance, the index component may be further configured to associate at least one of a time stamp, a location identifier, a media identifier and an owner identifier with each of the plurality of point representations. The index component may also be further configured to store at least one segment representation within the memory, the at least one segment representation may correspond to at least two of the plurality of point representations. In addition, the index component may be further configured to associate at least one of a start time, an end time, a title, a description, a thumbnail image, an owner identifier, and a location identifier with the at least one segment representation. Furthermore, the index component may be further configured to provide a representation of the at least one segment representation to a user interface.

The system may further include an event discovery component executed by the processor. The event discovery component may be configured to receive a target date via a user interface; determine at least one owner identifier associated with media information dated within a range of the target date; present, via the user interface, a representation of at least one owner corresponding to the at least one owner identifier; receive at least one selected owner selected via the user interface; present, via the user interface, at least one piece of media of the plurality of pieces of media, the at least one piece of media being associated with an owner identifier corresponding to the at least one selected owner; receive at least one selected piece of media selected via the user interface; and store at least one event representation within the to memory, the event representation corresponding to, and associated with, the target date, the at least one selected owner, and the at least one selected piece of media. The at least one event representation may include a segment representation.

The system may further include a memorable events discovery component executed by the processor. The memorable events discovery component may be configured to identify at least one cluster of media information dated within a range of a central date; and present, via the user interface, a representation of the at least one cluster. The at least one cluster may include a segment representation.

According to another embodiment, a method for organizing media across a plurality of websites is provided. The method includes acts of receiving a set of authentication credentials, each member of the set of authentication credentials corresponding to a respective website of the plurality of websites; executing a plurality of API calls, each API call of the plurality of API calls corresponding to a respective website of the plurality of websites, at least one API call of the plurality of API calls using a member of the set of authentication credentials; receiving a set of media information from at least one of the plurality of websites, each member of the set of media information corresponding to a respective piece of media of a plurality of pieces of media; and storing a plurality of point representations within the memory, each of the plurality of point representations corresponding to, and associated with, a respective piece of media of the plurality of pieces of media.

In the method, the act of executing the plurality of API calls may include an act of executing an API call corresponding to at least one of Facebook, Twitter, Google, Foursquare, and Flickr. The method may further include an acts of receiving a target date via a user interface; determining at least one owner identifier associated with media information dated within a range of the target date; presenting, via the user interface, a representation of at least one owner corresponding to the at least one owner identifier; receiving at least one selected owner selected via the user interface; presenting, via the user interface, at least one piece of media of the plurality of pieces of media, the at least one piece of media being associated with an owner identifier corresponding to the at least one selected owner; receiving at least one selected piece of media selected via the user interface; and storing at least one event representation within the memory, the event representation corresponding to, and associated with, the target date, the at least one selected owner, and the at least one selected piece of media. The act of storing the at least one event representation may include an act of storing a segment representation. The method may further include acts of identifying at least one cluster to of media information dated within a range of a central date and presenting, via the user interface, a representation of the at least one cluster. The act of identifying the at least one cluster may include an act of identifying a segment representation.

According to another embodiment, a non-transitory computer readable medium is provided. The computer readable medium stores sequences of instruction for organizing media across a plurality of websites. The sequences of instruction include instructions that will cause at least one processor to receive a set of authentication credentials, each member of the set of authentication credentials corresponding to a respective website of the plurality of websites; execute a plurality of API calls, each API call of the plurality of API calls corresponding to a respective website of the plurality of websites, at least one API call of the plurality of API calls using a member of the set of authentication credentials; receive a set of media information from at least one of the plurality of websites, each member of the set of media information corresponding to a respective piece of media of a plurality of pieces of media; and store a plurality of point representations within the memory, each of the plurality of point representations corresponding to, and associated with, a respective piece of media of the plurality of pieces of media.

In this embodiment, the instructions may further instruct the at least one processor to receive a target date via a user interface; determine at least one owner identifier associated with media information dated within a range of the target date; present, via the user interface, a representation of at least one owner corresponding to the at least one owner identifier; receive at least one selected owner selected via the user interface; present, via the user interface, at least one piece of media of the plurality of pieces of media, the at least one piece of media being associated with an owner identifier corresponding to the at least one selected owner; receive at least one selected piece of media selected via the user interface; and store at least one event representation within the memory, the event representation corresponding to, and associated with, the target date, the at least one selected owner, and the at least one selected piece of media. The instructions may further instruct the at least one processor to identify at least one cluster of media information dated within a range of a central date and present, via the user interface, a representation of the at least one cluster.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example or embodiment disclosed herein may be combined with any other embodiment or example. References to “an embodiment,” “an example,” “some embodiments,” “some examples,” “an alternate embodiment,” “various embodiments,” “various examples,” “one embodiment,” “one example,” “at least one embodiment,” “this and other embodiments,” or the like are not necessarily mutually exclusive and are intended to indicate that a particular feature, structure, or characteristic described in connection with the example or embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic context diagram including a media organization system;

FIG. 2 is a schematic diagram of one example of a computer system that may perform processes and functions disclosed herein;

FIG. 3 is a flow diagram illustrating a process of discovering media;

FIG. 4 is a flow diagram illustrating a process of refreshing a media index;

FIG. 5 is a flow diagram illustrating a process of creating a record of an event from user specified information;

FIG. 6 is a flow diagram illustrating a process for creating a record of an automatically identified memorable event;

FIG. 7 is a flow diagram illustrating a process for managing website authentication credentials;

FIG. 8 is an exemplary screen for collecting a date displayed by a user interface;

FIG. 9 is an exemplary screen for collecting a date or a selecting a piece of media displayed by a user interface;

FIG. 10 is an exemplary screen for selecting attendees of an event displayed by a user interface;

FIG. 11 is an exemplary screen for selecting media associated with an event displayed by a user interface;

FIG. 12 is an exemplary screen including a representation of an event displayed by a user interface;

FIG. 13 is an exemplary screen displaying a status of a process for detecting memorable events;

FIG. 14 is a schematic context diagram including a media organization component;

FIG. 15 is a flow diagram illustrating an alternative process of discovering media;

FIG. 16 is a flow diagram illustrating an alternative process of refreshing a media index;

FIG. 17 is a flow diagram illustrating an alternative process of creating a record of an event from user specified information;

FIG. 18 is a flow diagram illustrating an alternative process for creating a record of an automatically identified memorable event; and

FIG. 19 is a flow diagram illustrating an alternative process for managing media source authentication credentials.

### DETAILED DESCRIPTION

According to various embodiments described herein, a computer system executes a process that indexes, stores, and retrieves references to data stored within multiple websites. These data include media assets. Media assets, which are also referred to herein simply as “media,” may include any content that can be stored by a computer system. Examples of media assets include photos, videos, text information, such as tweets and status updates, and metadata descriptive of the content.

The websites in which these media assets are stored may be identified by domain names, internet protocol addresses, universal resource locators (“URLs”), etc. within a domain name system and may include social networking websites and media-sharing websites that have discrete and individually structured media databases. Further, each of these websites may expose a different API through which the website exchanges media information. According to one embodiment, the computer system stores the references in a unified and normalized index by creating “points” and “segments” based on time, location, and user. In this embodiment, a to point is a representation of media that is stored on a website.

In some embodiments, the computer system creates a segment that references a series of one or more points. In these embodiments, the computer system associates the segment with series of points, a period of time, and an identified user. In at least one embodiment, a segment includes information identifying an owner ID, start time, end time, title, location, summary, privacy settings, tags, event information, one or more points associated with the segment, and a list of other users associated with the segment. Through the references stored in the normalized index, embodiments disclosed herein can associate two or more pieces of media from different websites with a single user or event.

In other embodiments, the computer system provides a user interface through which an external entity, such as a user or external system, accesses and manages the index or data referred to within the index. In these embodiments, the user interface retrieves and manipulates points, segments, and combinations of both. In this way, the user interface provides a single portal through which a user may access and manage data distributed among multiple websites.

According to some embodiments, the user interface receives information identifying an event of interest to a user. This identifying information may represent one or more time periods or one or more attendees of the event. Responsive to receipt of the identifying information via the user interface, the computer system discovers media associated with the event that resides on one or more websites and creates references to the media. In other embodiments, the computer system determines identifying information for multiple memorable events within the life of a user and utilizes the identifying information to discover media associated with the memorable events.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Media Organization System

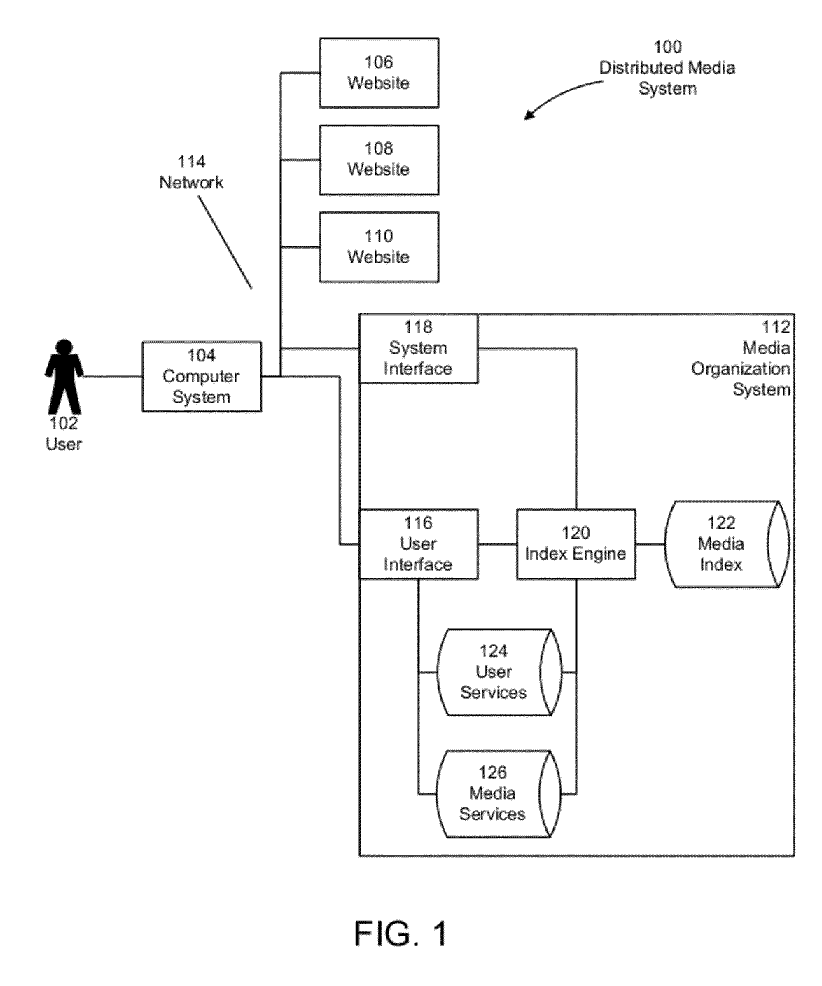

Various embodiments disclosed herein implement a media organization system using one or more computer systems. As described further below, a media organization system identifies, normalizes, and manages media assets and accounts across multiple websites, identifies events of interest to users and discovers media associated with these events. FIG. 1 illustrates an exemplary distributed media system 100 including one of these embodiments. As shown, FIG. 1 includes a user 102, a computer system 104, websites 106, 108, and 110, a media organization system 112, and a communication network 114.

As illustrated in FIG. 1, the computer system 104, the websites 106, 108, and 110, and the media organization system 112 exchange (i.e. send or receive) information via the network 114. For instance, the computer system 104 may exchange information with the media organization system 112 or the websites 106, 108, and 110 through the network 114. Similarly, the media organization system 112 may exchange information with the websites 106, 108, and 110 through the network 114. The network 114 may include any communication network through which computer systems exchange information. For example, the network 114 may be a public network, such as the internet, and may include other public or private networks such as LANs, WANs, extranets, and intranets.

In the embodiment illustrated in FIG. 1, the media organization system 112 includes several components: a user interface 116, a system interface 118, an index engine 120, a media index data storage (“media index”) 122, a user services data storage 124, and a media services data storage 126. The media index 122 includes a variety of data structures and data elements including both points and segments. Although depicted as being stored in separate storage to locations, the media index 122, the user services data storage 124, and the media service data storage 126 may be stored on the same physical storage medium.

In some embodiments, a point is a representation of a piece of media. According to one embodiment, the data structure of a point includes a time stamp field, a location identifier field, a media identifier field, and an owner identifier field. The time stamp field stores information that indicates a date and time that the piece of media represented by the point was created or dated. The information within the time stamp field may be encoded in a variety of formats, including in Universal Time Code (“UTC”) time. The location identifier field stores information that indicates a geographic location associated with the piece of media, such as where the media was created. The information within the location identifier field may be encoded in various formats, including a set of global positioning system (“GPS”) coordinates or a free-form text string indicative of a geographic location. The media identifier field stores information that identifies a location of media information within the media services data storage 126 that is associated with the piece of media. The information within the media identifier field may be encoded in sundry formats, including an integer or alphanumeric string value indicative of a position within the media services data storage 126. The owner identifier field stores information that identifies a location of user information within the user services data storage 124. The information within the user identifier field may be encoded in a variety of formats, including an integer or alphanumeric string value indicative of a position within the user services data storage 124.

In other embodiments, a segment is a representation of a block of one or more points. According to one embodiment, the data structure of a segment includes a start time field, an end time field, a timezone field, a title field, a description field, a thumbnail image field, an owner identifier field, and a location identifier field. The start time field stores information that indicates a value stored in the time stamp field of the earliest point in the block of points, such as the UTC time stored in the time stamp field of the earliest point. The end time field stores information that indicates a value stored in the time stamp field of the latest point in the block of points, such as the UTC time stored in the time stamp field of the latest point. The timezone field stores information that indicates a timezone of the location of the segment. The information within the timezone field may be encoded in a variety of formats, including an integer or alphanumeric string indicating a Greenwich Mean Time (“GMT”) offset. The title field stores information that indicates a title of the segment. The information within the title field may be encoded in various formats, including a text string. The description field stores to information that indicates a description of the segment. The information within the description field may be encoded in sundry formats, including a text string. The thumbnail image field stores information that identifies a location of media information within the media services data storage 126 that is associated with the segment. The information within the thumbnail image field may be encoded in assorted formats, including an integer or alphanumeric string value indicative of a position within the media services data storage 126. The owner identifier field stores information that identifies a position of user information within the user services data storage 124. The information within the user identifier field may be encoded in any of several formats, including an integer or alphanumeric string value indicative of a position within the user services data storage 124. The location identifier field stores information that indicates a geographic location associated with the segment. The information within the location identifier field may be encoded in a number of formats, including a set of global positioning system (“GPS”) coordinates or a free-form text string indicative of a geographic location. In some embodiments, segments are associated with points using a table that relates segment identifiers with point identifiers. In other embodiments, segments include an additional field that stores information that identifies the one or more points that are associated with the segment. Thus particular embodiments are not limited to particular methods of storing associations.

The user services data storage 124 includes a variety of data structures and data elements used by the media organization system 112 to normalize user accounts, such as those associated with the user 102, across one or more websites, such as the websites 106, 108, and 110. According to one embodiment, the user services data storage 124 includes a table with each row representing a discrete user. The data structure of each row includes a user identifier field, a service identifier field, an authentication credentials field, and a privacy settings field. The user identifier field stores information that indicates an identifier of a user of the media organization system 112, such as the user 102. The information within the user identifier field may be encoded in a variety of formats, including a dynamically generated unique integer or alphanumeric string associated with the user. The service identifier field stores information that indicates a website that stores media to which the user has access. The information within the service identifier field may be encoded in various formats, including a text string indicative of a domain name or URL of the website. Examples of websites stored in the service field identifier include Facebook, Twitter, Google, Foursquare, and Flickr, among others. The authentication credentials field stores information that indicates a set of authentication credentials associated with the user through which access to the user's account on the website indicated in the service field identifier may be granted. The information within the authentication credentials field may be encoded in various formats, including a text string indicative of a user logon and password for the website. In some examples, the user services data storage 124 stores the user's authentication credentials for all of the websites storing media associated with the user. The privacy settings field stores information that indicates privacy settings of the user for the website indicated in the service field identifier. The information within the user identifier field may be encoded in a variety of formats as required to support the privacy settings made available by the website indicated in the service field identifier.

The media services data storage 126 includes a variety of data structures and data elements used by the media organization system 112 to normalize media associated with a user, such as those associated with the user 102, across one or more websites, such as the websites 106, 108, and 110. According to one embodiment, the media services data storage 126 includes a table with each row representing a discrete piece of media. The data structure of each row includes a media identifier field, a time stamp field, a location identifier field, an owner identifier field, a service identifier field, and a service metadata field. The media identifier field stores information that identifies a piece of media within the media organization system 112. The information within the media identifier field may be encoded in sundry formats, including a dynamically generated unique integer or alphanumeric string value associated with the media. The time stamp field stores information that indicates a date and time that the piece of media was created or dated. The information within the time stamp field may be encoded in a variety of formats, including in Universal Time Code (“UTC”) time. The location identifier field stores information that indicates a geographic location associated with the piece of media, such as where the media was created. The information within the location identifier field may be encoded in various formats, including a set of global positioning system (“GPS”) coordinates or a free-form text string indicative of a geographic location. The owner identifier field stores information that identifies a position of user information within the user services data storage 124. The information within the user identifier field may be encoded in any of several formats, including an integer or alphanumeric string value indicative of a position within the user services data storage 124. The service identifier field stores information that indicates a website that stores the media. The information within the service identifier field may be encoded in various formats, including a text string indicative of a to domain name or URL of the website. The service metadata field stores information that indicates an address of the piece of media within the website. The information within the service metadata field may be encoded in a number of formats, including a URL associated with the media as stored in the website. In some embodiments, the data structure of the media service data storage 126 includes additional fields that store metadata made available by the website storing the piece of media.

Information within the distributed media system 100, including data within the media index 122, the user services data storage 124, and the media services data storage 126 may be stored in any logical construction capable of holding information on a computer readable medium including, among other structures, file systems, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance. In some embodiments, the owner identifier fields and the media identifier fields within the media index 122 are foreign keys linked to corresponding fields within the user services data storage 124 and the media services data storage 126.

Returning to the example illustrated in FIG. 1, the user interface 116 is configured to interact with the user 102 via the network 114 and the computer system 104. The user interface 116 may employ a variety of metaphors and user interface elements to provide and receive information. Particular embodiments of the user interface 116 are not limited to any one metaphor or configuration of user interface elements. For instance, in one embodiment, the user interface 116 serves a browser-based user interface to the user 102 that is rendered by a web-browser running on the computer system 104. The user interface 116 exchanges a variety of information with the user 102. This information may include any of the information described above with reference to the media index 122, the user services data storage 124, and the media services data storage 126.

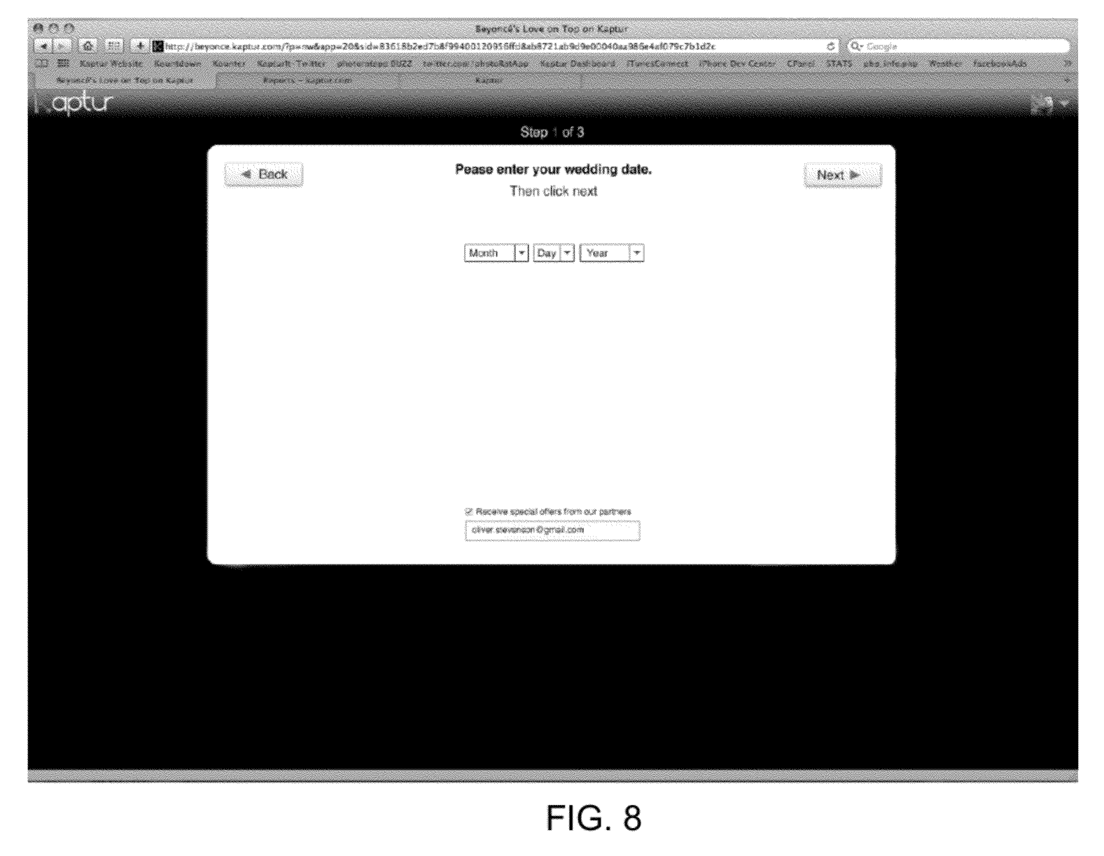

While exchanging information with applications running on the computer system 104, the user interface 116 executes application program interface (“API”) calls to the index engine 120. The API calls executed by the user interface 116 may include any API call supported by the index engine 120 described below. Screens presented by one embodiment of the user interface 116 are described further below with reference to FIGS. 8-13.

As illustrated in FIG. 1, the system interface 118 is configured to interact with the computer system 104 and the websites 106, 108, and 110 via the network 114. The system interface 118 may employ a variety of protocols to exchange information with the computer system 104 and the websites 106, 108, and 110. For instance, in one embodiment, the system interface 118 communicates with the computer system 104 and the websites 106, 108, and 110 using hypertext transfer protocol (“HTTP”). The system interface 118 exchanges a variety of information with the computer system 104 and the websites 106, 108, and 110. This information may include any of the information described above with reference to the media index 122, the user services data storage 124, and the media services data storage 126.

In some examples, applications executing on the computer system 104 access and manage media stored on the websites 106, 108, and 110 by exchanging information with the system interface 118. In these examples, the system interface 118 communicates with both the index engine 120 and the websites 106, 108, and 110 to process information provided by the applications executing on the computer system 104. While exchanging information with applications running on the computer system 104 and the websites 106, 108, and 110, the system interface 118 executes API calls to the index engine 120. The API calls executed by the system interface 118 may include any API call supported by the index engine 120 described below.

In the example shown in FIG. 1, the index engine 120 is configured to service API calls received via the user interface 116 and the system interface 118. The API calls serviced by the index engine 120 include read functions and write functions. In one embodiment, the read functions serviced by the index engine 120 include getSegmentsByUser(user identifier); getSegmentsByTime(start time, end time); getSegmentsByLocation(location); getPointsBySegment(segment identifier); getPointsByUser(user identifier); getPointsByUsers(list of user identifiers); getPointsByTime(start time, end time); getPointsByLocation(location); getPointsByUsersAndTime(list of user identifiers, start time, end time); getPointsByUsersAndLocation(list of user identifiers, location); and getPointsByTimeAndLocation(start time, end time, location). The getSegmentsByUser(user identifier) function returns one or more segments stored within the media index 122 that are owned by the user identified by the user identifier specified in the API call. The getSegmentsByTime(start time, end time) function returns one or more segments stored within the media index 122 with a start time and end time falling between or upon the start time and the end time specified in the API call. The getSegmentsByLocation(location) function returns one or more segments stored within the media index 122 with a location identifier associated with the location specified in the API call. The getPointsBySegment(segment identifier) function returns one or more points stored within the media index 122 associated with the segment identifier specified in the API call. The getPointsByUser(user identifier) function returns one or more points stored within the media index 122 associated with the user identifier specified in the API call. The getPointsByUsers(list of user identifiers) function returns one or more points stored within the media index 122 associated with any user listed in the list of users specified in the API call. The getPointsByTime(start time, end time) function returns one or more points stored within the media index 122 having a time stamp falling between or upon the start time and the end time specified in the API call. The getPointsByLocation(location) function returns one or more points stored within the media index 122 having a location identifier associated with the location specified in the API call. The getPointsByUsersAndTime(list of user identifiers, start time, end time) function returns one or more points stored within the media index 122 associated with any user listed in the list of users specified in the API call and having a time stamp falling between or upon the start time and the end time specified in the API call. The getPointsByUsersAndLocation(list of user identifiers, location) function returns one or more points stored within the media index 122 associated with any user listed in the list of users specified in the API call and having a location identifier associated with the location specified in the API call. The getPointsByTimeAndLocation(start time, end time, location) function returns one or more points stored within the media index 122 having a time stamp falling between or upon the start time and the end time specified in the API call and having a location identifier associated with the location specified in the API call.

In another embodiment, the write functions serviced by the index engine 120 include createPoint(time, location, user); createMedia(time, location, owner, partner, metadata); createSegment(start time, end time, timezone, title, description, owner, thumbnail, location); pairPointAndMedia(point identifier, media identifier); pairPointWithPoint(point identifier, point identifier); pairPointWithUser(point identifier, user identifier); editPoint(point identifier, time, location, user); editMedia(time, location, owner, partner, metadata); and deletePoint(point identifier). The createPoint(time, location, user) function creates a point in the media index 122 having a time stamp field storing a value equal to the time specified in the API call, a location identifier field storing a value equal to the location specified in the API call, and an owner identifier field storing a value equal to the user specified in the API call. The createMedia(time, location, owner, partner, metadata) function creates an entry in the to media services data storage 126 having a time stamp field storing a value equal to the time specified in the API call, a location identifier field storing a value equal to the location specified in the API call, an owner identifier field storing a value equal to the owner specified in the API call, a service identifier field storing a value equal to the partner specified in the API call, and a service metadata field storing a value equal to the metadata specified in the API call. The createSegment(start time, end time, timezone, title, description, owner, thumbnail, location) function creates a segment in the media index 122 having a start time field storing a value equal to the start time specified in the API call, an end time field storing a value equal to the end time specified in the API call, a timezone field storing a value equal to the timezone specified in the API call, a title field storing a value equal to the title specified in the API call, a description field storing a value equal to the description specified in the API, an owner field storing a value equal to the owner specified in the API call, a thumbnail identifier field storing a value equal to the thumbnail specified in the API call, and a location identifier field storing a value equal to the location specified in the API call. The pairPointAndMedia(point identifier, media identifier) function associates the point specified in the API call with the piece of media specified in the API call by storing the value of the media identifier specified in the API call within the media identifier field of the point identified by the point identifier specified in the API call. The pairPointWithPoint(point identifier, point identifier) function stores, within the media index 122, an association between the points identified the point identifiers specified in the API call. The pairPointWithUser(point identifier, user identifier) function stores an association between the point identified in the API call and the user identified in the API call. The editPoint(point identifier, time, location, user) function stores the value of the time specified in the API call within the time stamp field of the point identified by the point identifier specified in the API call, stores the value of the location specified in the API call within the location identifier field of the point identified by the point identifier specified in the API call, and stores the value of the user specified in the API call within the owner identifier field of the point identified by the point identifier specified in the API call. The editMedia(media, time, location, owner, partner, metadata) function stores the value of the time specified in the API call within the time stamp field of the media service data storage entry identified by the media identifier specified in the API call, stores the value of the location specified in the API call within the location identifier field of the media service data storage entry identified by the media identifier specified in the API call, stores the value of the owner specified in the API call within the owner identifier field of the media service data storage entry identified by the media identifier specified in the API call, and stores the value of the metadata specified in the API call within the service metadata field of the media service data storage entry identified by the media identifier specified in the API call. The deletePoint(point identifier) function deletes, from the media index 122, the point identified by the point identifier specified in the API call. Through the use of the media index 122, embodiments disclosed herein can create one-to-one, one-to-many, many-to-many, and many-to-one relationships between separate pieces of media, between separate users, and between users and media. Some embodiments use these relationships to establish associations between users that are not recognized by systems external to the media organization system 112.

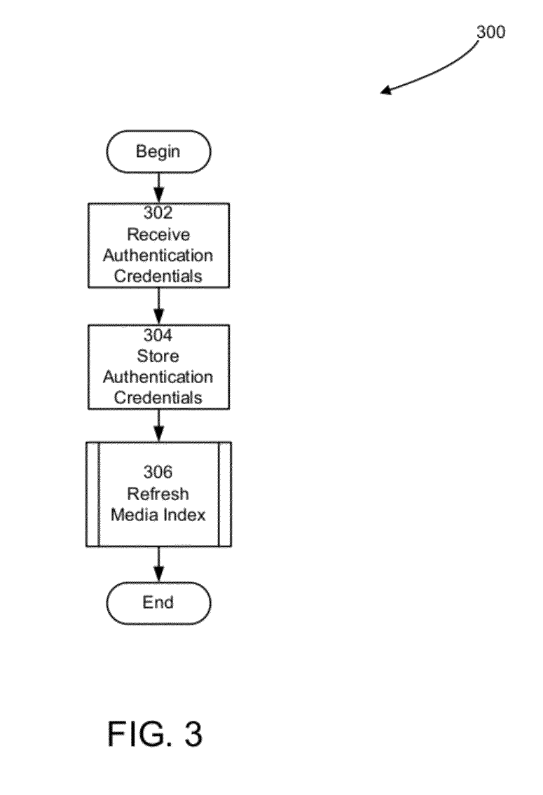

In other embodiments, the index engine 120 performs additional processes via additional components. In some of these embodiments, the index engine 120 loads and executes an event discovery component. In others of these embodiments, the index engine 120 loads and executes a memorable events discovery component. In still other embodiments, the index engine 120 loads and executes a refresh component. These components and other processes executed by the index engine 120 are described further below with reference to FIGS. 3-6.

Information may flow between the components illustrated in FIG. 1, or any of the elements, components and subsystems disclosed herein, using a variety of techniques. Such techniques include, for example, passing the information over a network using standard protocols, such as TCP/IP or HTTP, passing the information between modules in memory and passing the information by writing to a file, database, data store, or some other nonvolatile data storage device. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

The interfaces disclosed herein, which include both system interfaces and user interfaces, exchange (i.e. provide or receive) information with various providers and consumers. These providers and consumers may include any external entity including, among other entities, users and systems. In some embodiments, functions provided to systems by the system interfaces are also provided to users via the user interfaces. Conversely, in other embodiments, functions provided to users by the user interfaces are also provided to systems via the systems interfaces. Each of the interfaces disclosed herein may both restrict input to a predefined set of values and validate any information entered prior to using the information or providing the information to other components. Additionally, each of the interfaces disclosed herein may validate the identity of an external entity prior to, or during, interaction with the external entity. These functions may prevent the introduction of erroneous data or unauthorized access in the systems disclosed herein.

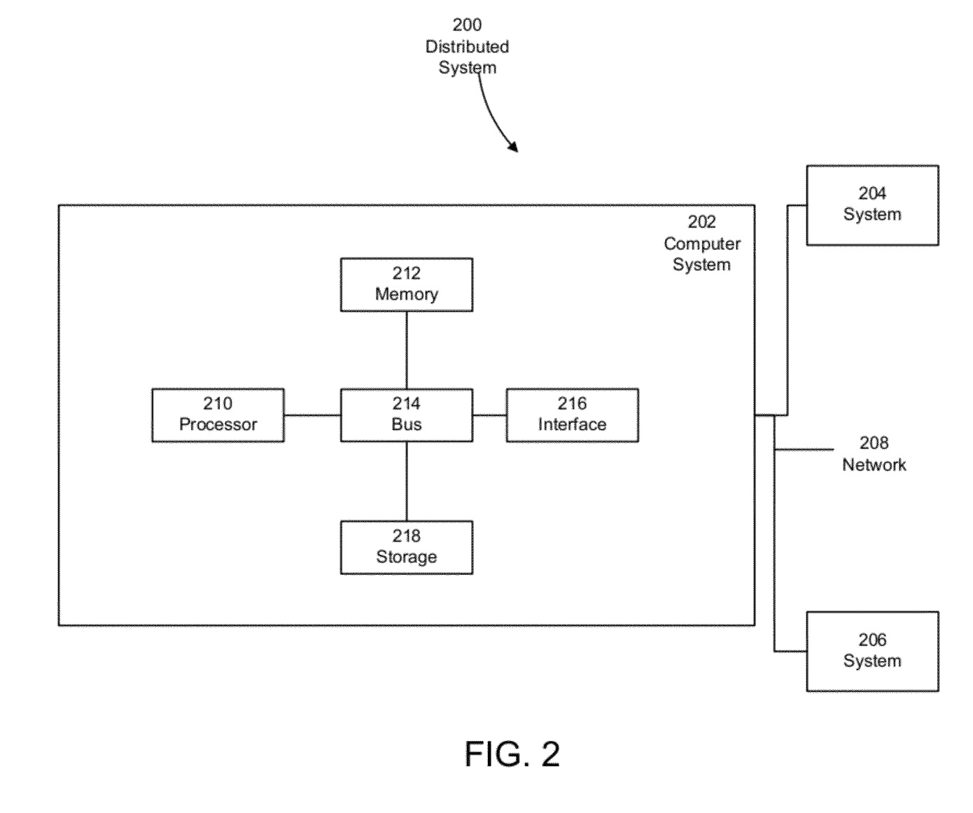

Embodiments disclosed herein are not limited to the particular configuration illustrated in FIG. 1. Various embodiments utilize a variety of hardware components, software components and combinations of hardware and software components configured to perform the processes and functions described herein. For instance, in at least one embodiment, the media organization system 112 and the computer system 104 are implemented using a computer system, such as the computer systems described below with reference to FIG. 2. In some examples, the distributed media system 100 is implemented using a distributed computer system, such as the distributed computer system described further below with regard to FIG. 2.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 2, there is illustrated a block diagram of a distributed computer system 200, in which various aspects and functions are practiced. As shown, the distributed computer system 200 includes one more computer systems that exchange information. More specifically, the distributed computer system 200 includes computer systems 202, 204 and 206. As shown, the computer systems 202, 204 and 206 are interconnected by, and may exchange data through, a communication network 208. The network 208 may include any communication network through which computer systems may exchange data. To exchange data using the network 208, the computer systems 202, 204 and 206 and the network 208 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 202, 204 and 206 may transmit data via the network 208 using a variety of security measures including, for example, TLS, SSL or VPN. While the distributed computer system 200 illustrates three networked computer systems, the distributed computer system 200 is not so limited and may include any number of computer systems and computing devices, networked using any medium and communication protocol.

As illustrated in FIG. 2, the computer system 202 includes a processor 210, a memory 212, a bus 214, an interface 216 and data storage 218. To implement at least some of the aspects, functions and processes disclosed herein, the processor 210 performs a series of instructions that result in manipulated data. The processor 210 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 210 is connected to other system components, including one or more memory devices 212, by the bus 214.

The memory 212 stores programs and data during operation of the computer system 202. Thus, the memory 212 may be a relatively high performance, volatile, random access memory such as a dynamic random access memory (DRAM) or static memory (SRAM). However, the memory 212 may include any device for storing data, such as a disk drive or other nonvolatile storage device. Various examples may organize the memory 212 into particularized and, in some cases, unique structures to perform the functions disclosed herein. These data structures may be sized and organized to store values for particular data and types of data.

Components of the computer system 202 are coupled by an interconnection element such as the bus 214. The bus 214 may include one or more physical busses, for example, busses between components that are integrated within a same machine, but may include any communication coupling between system elements including specialized or standard computing bus technologies such as IDE, SCSI, PCI and InfiniBand. The bus 214 enables communications, such as data and instructions, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and to communicate with external entities, such as users and other systems.

The data storage 218 includes a computer readable and writeable nonvolatile, or non-transitory, data storage medium in which instructions are stored that define a program or other object that is executed by the processor 210. The data storage 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage 218. The memory may be located in the data storage 218 or in the memory 212, however, the processor 210 manipulates the data within the memory, and then copies the data to the storage medium associated with the data storage 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having a different architectures or components than that shown in FIG. 2. For instance, the computer system 202 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Windows-based operating system, such as Windows NT, Windows 2000 (Windows ME), Windows XP, Windows Vista or Windows 7 operating systems, available from the Microsoft Corporation, a MAC OS System X operating system available from Apple, Inc., one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, to functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read configurable parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Media Organization Processes

According to one example illustrated by FIG. 1, the user 102 interacts with the computer system 104 to provide media to various websites including the websites 106, 108, and 110. Examples of this media include photographs, videos, text messages, tweets, and status updates. Each of the websites 106, 108, and 110 stores the media provided by the user 102 and media provided by other users. In addition, each of the websites 106, 108, and 110 stores metadata associated with the media. This metadata may include commentary describing the media, information describing the quality of the media, such as “likes” or “dislikes”, and information identifying characteristics depicted in the media.

According to some embodiments, a media organization system, such as the media organization system 112 describe above with reference to FIG. 1, performs processes that discover media associated with a user. One example of such a process is illustrated in FIG. 3. According to this example, a process 300 includes acts of receiving authentication credentials, storing the authentication credentials, and refreshing a media index.

In act 302, the media organization system receives a set of authentication credentials for a user. In at least one embodiment, the set of authentication credentials is received via a user interface, such as the user interface 116 described above with reference to FIG. 1. The set of authentication credentials may include a user logon and password for one or more websites that store media associated with the user.

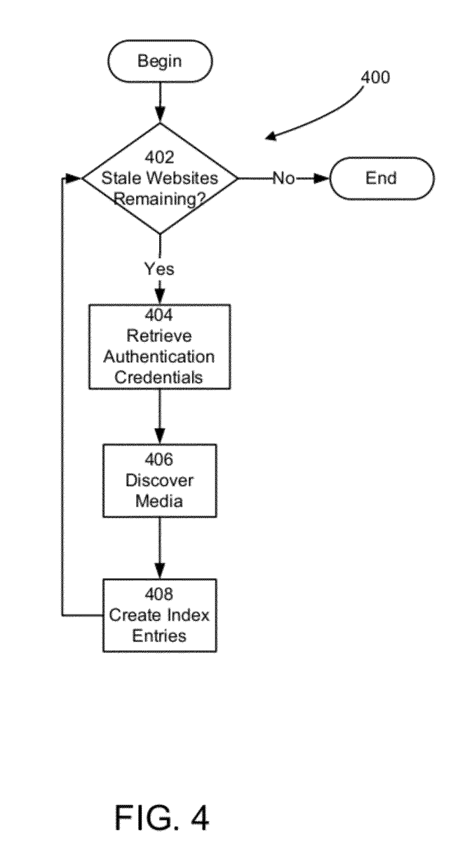

In act 304, the media organization system stores the set of authentication credentials in a data storage, such as the user services data storage 124. Next, in act 306, the media organization system refreshes its media index. In at least one embodiment, an index engine of the media organization system, such as the index engine 120, refreshes a media index, such as the media index 122 by executing a refresh process. This refresh process is described further below with reference to FIG. 4. Upon completion of the act 306, the media organization system terminates the process 300.

Processes such as the process 300 enable a media organization system to maintain a current set of references to media recently uploaded by its users.

Other embodiments perform processes that refresh a media index based on newly discovered media information. In some of these embodiments, an index engine, such as the index engine 120, includes a refresh component configured to execute these processes. One example of a refresh process that can be executed by the refresh component is illustrated in FIG. 4. According to this example, the refresh process 400 includes acts of determining whether stale websites remain unprocessed, retrieving authentication credentials, discovering media and creating index entries.

In act 402, the media organization system determines whether any stale websites remain unprocessed. According to some embodiments, an index engine, such as the index engine 120, make this determination for the media organization system by retrieving a time stamp of a previous attempt to discover media on the target site from the media services data storage 126. In these embodiments, the index engine deems a target website as stale where a threshold period of time, for example two days, has elapsed since the previous attempt. In some embodiments, this threshold period of time is a configurable parameter. If no stale websites remain unprocessed, the index engine terminates the process 400. Otherwise, the index engine retrieves authentication credentials for the next target website in act 404.

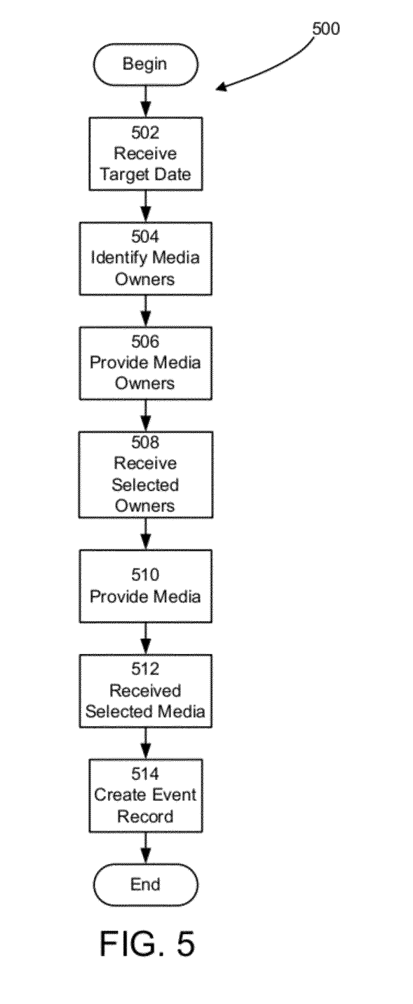

Next, in act 406, the index engine uses the authentication credentials to discover any media that meets a set of search criteria and that is stored on the target website. In some embodiments, these search criteria may require that the media be associated with the user or an event. In at least one embodiment, the index engine, via a system interface such as the system interface 118, first authenticates the media organization system with the target website using the authentication credentials of the user. It is to be appreciated that some target websites may authenticate based solely on identification, (for example, some target websites may allow access to media information when presented with an identifier of a user without an accompanying password). Next, the index engine requests media associated with the user by issuing API calls to the target website in a format subscribing to the requirements of the target website. In at least some embodiments, which are described further below with reference to FIG. 5, the index engine requests media associated with a specific event (i.e., media dated within a predetermined range of dates or associated with particular users other than the currently authenticated user).

In response to the requests for media, the target website provides media information associated with the user. This media information may include both media associated with the user and metadata describing the media and the user's social network, such as the activities of other users associated with the user. The index engine receives this media information via the system interface. In this embodiment, the API calls in act 406 are issued to the websites using server side PHP libraries. In other embodiments, the API calls in act 406 are issued to the websites using client side JavaScript libraries.

Media associated with the user may be media uploaded and “owned” by the user. Media associated with the user may also include media uploaded and “owned” by others. For instance, in one embodiment, the index engine associates some pieces of media uploaded by others with the user by virtue of the user being associated with the other users on a website. Various websites may determine associations between the user and other users using a variety of techniques. For instance, websites may associate the user with other users who are “friends” of the user, who are engaged in a “following” relationship with the user, who share media with the user, who are within circles managed by the user, or who in within the same circles as the user.

In some embodiments, the index engine associates other pieces of media with the user by virtue of the media being tagged with an identifier of the user. In other embodiments, the index engine associates other pieces of media with the user by virtue of the media being associated with a comment that includes an identifier of the user. The index engine may execute the pairPointWithUser( ) to store these associations.

In some embodiments, the index engine further establishes associations between users that are not recognized within a websites. In these embodiments, the index engine associates users who have associations with a common piece of media, regardless of whether the users are associated within a website. Actions performed by the index engine to establish these associations include scanning the media index to find pieces of media associated with more than one user and associating the users found by the scanning process.

In act 408, the index engine creates index entries, such as points or segments, within the media index for any newly discovered or changed media and then executes the act 402. For example, in one embodiment, the index engine executes the createMedia( ) function to create a new entry in the media services data storage 126 for each piece of discovered media, executes the createPoint( ) function to create a new point in the media index 122 for each piece of discovered media, and executes the pairPointAndMedia( ) function to associate the new points with the new entries in a one-to-one manner. Further, the index engine may execute the createSegment( ) function to create a segment including a range of points.

In at least one embodiment, the index engine also downloads, via the system interface, the newly discovered pieces of media to local data storage, such as the media services data storage 126. In this embodiment, the media organization system is able to provide downloaded media to the user via the user interface in an off-line mode, i.e. when the media organization system is not connected to the internet.

Upon completion of the process 400, the media organization system may provide newly discovered media to a user via a user interface, such as the user interface 116. In some embodiments, the user interface provides both newly discovered and known media according the privacy settings currently in force on each website. Processes such as the process 400 enable the media organization system to act as a central administrator of media stored on a plurality of websites. Through its system and user interfaces, the media organization system may be used by both systems and users to access and control media stored within multiple websites.

Other embodiments perform processes that discover events associated with media stored on one or more target websites. Some of these processes discover events based on identification information entered by a user. Further, in some embodiments, an index engine, such as the index engine 120, includes an event discovery component configured to execute the processes. One example of a process that can be executed by the event discovery component is illustrated in FIG. 5. According to this example, the event discovery process 500 includes several acts that are described further below.

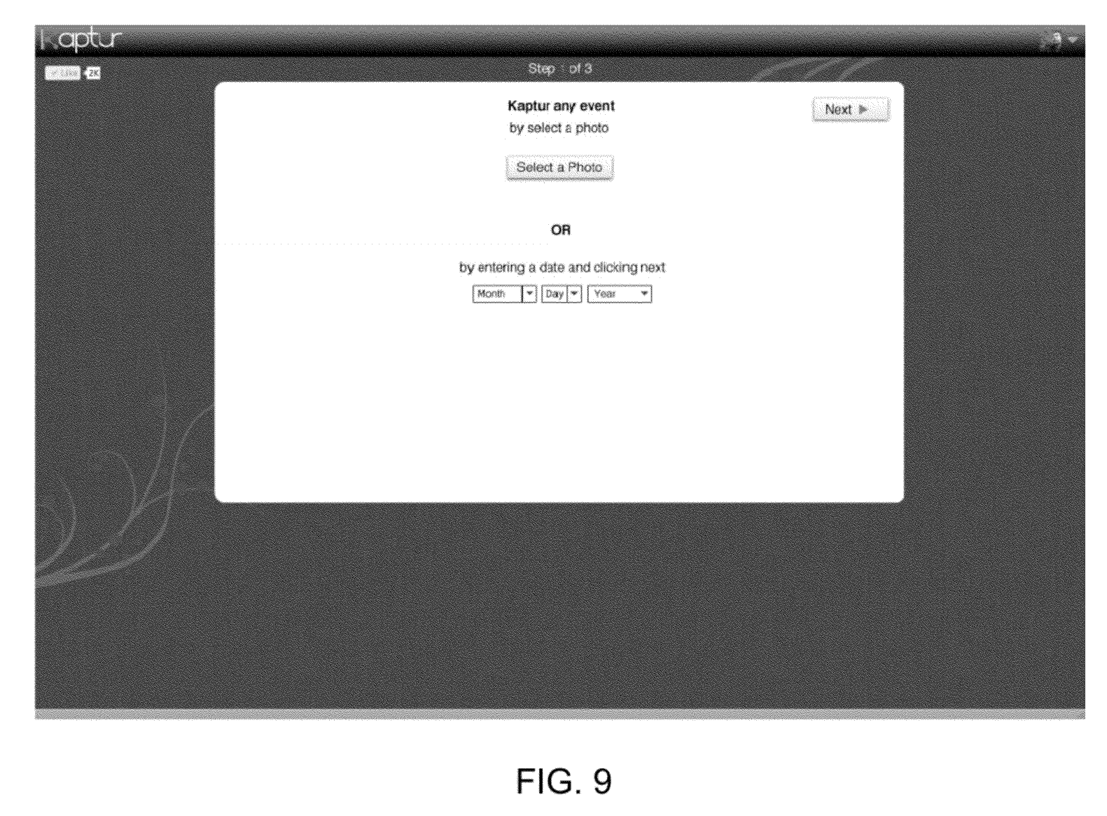

In act 502, the media organization system receives and stores, via an interface such as the user interface 116 or the system interface 118, a target date of an event from an external entity, such as a user or a computer system, interested in organizing media depicting the event within the media organization system. FIGS. 8 and 9 illustrate exemplary screens presented by the user interface in the act 502. According to the example illustrated in FIG. 8, the screen includes elements that prompt the user to enter the target date. According to the example illustrated in FIG. 9, the screen includes elements that prompt the user to enter the target date or to identify a piece of media (a photograph). In the example illustrated in FIG. 9, the user interface sets the value of the target date to equal the value of the creation date of the identified piece of media.

Next, in act 504, the media organization system identifies, on each target website, media associated with the interested user that is dated with a date falling within a predetermined range, for example 5 days, of the target date of the event. The media organization system may also identify users who own the associated media. In illustrated embodiment, the media organization system performs these identifications by executing an index engine, such as the index engine 120, and the predetermined range used by the index engine is a configurable parameter. More particularly, in the act 504, the index engine authenticates, via a system interface such as the system interface 118, the media organization system with each target website, requests media stored on each target website that is associated with the interested user and that is dated with a date falling within the predetermined date range, and identifies the associated users who own any media returned by the websites.

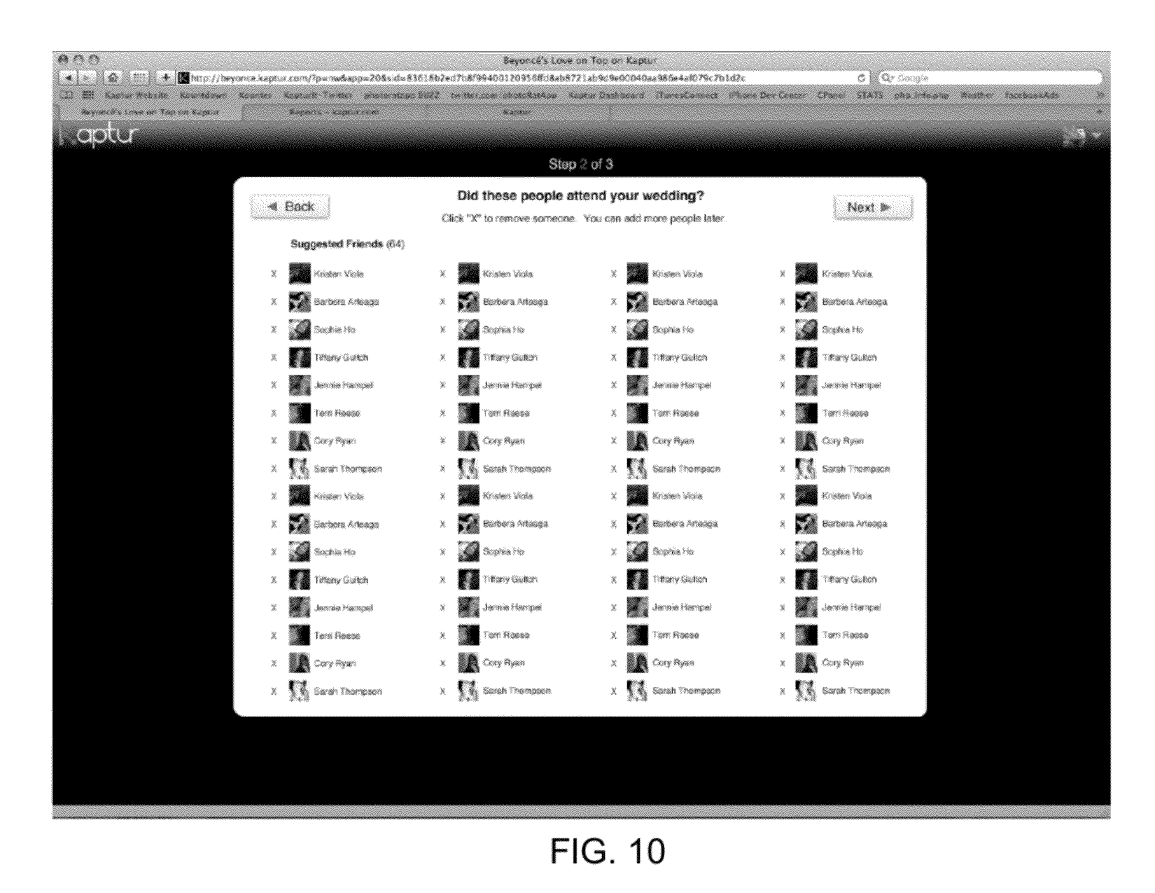

In act 506, the index engine presents any identified users to the interested user via the user interface. FIG. 10 illustrates an exemplary screen displayed by the user interface in the act 506. As shown in FIG. 10, the screen includes elements through which the user interface receives a selected set of the identified users. The screen also includes elements, labeled “Back” and “Next,” that when actuated cause the user interface to navigate to the previous and next screens within the user interface.

In act 508, the index engine receives and stores, from the interested user via the user interface, a set of selected users identified as having media depicting the event. In response to receiving the set of selected users, the index engine stores an association between the selected users and the interested user and an association between the selected users and the event. In some embodiments, these associations are stored in conjunction with points and segments in the media index. These associations may be later used to “refresh” the media associated with the event, where, for example, the selected users upload additional media depicting the event after the event is initially discovered via execution of the process 500. In this way, when executing a refresh process, such as the refresh process 400 described above with reference to FIG. 4, for a previously recorded event, the index engine may use the target date (or the date range) and the selected users from the previously recorded event to gather media from the websites, rather than redundantly querying the user for a previously specified target date and selected users.

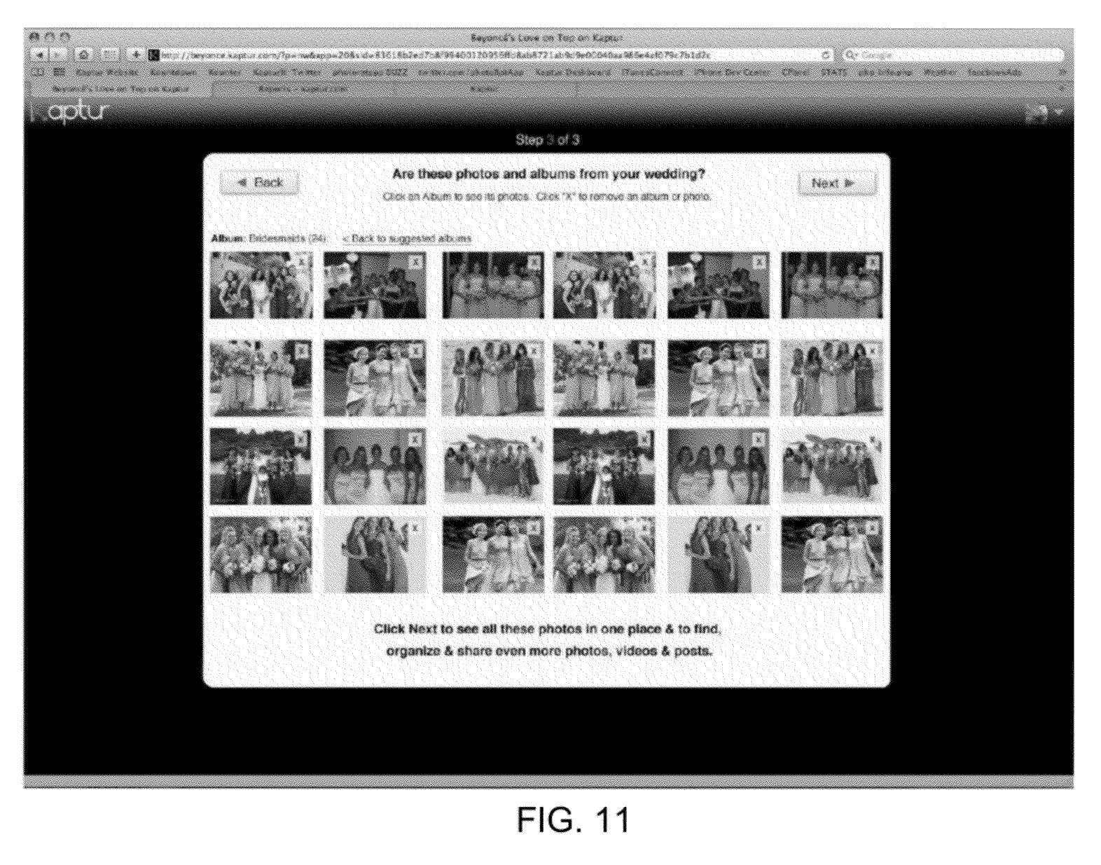

In act 510, the index engine presents, via the user interface, representations of the pieces of media associated with the identified users and representations of the media associated with the interested user that is dated with a date falling within the predetermined range of the target date. FIG. 11 illustrates an exemplary screen presented by the user interface in the act 510.

In act 512, the index engine receives and stores, from the interested user via the user interface, a set of selected pieces of media identified as depicting the event. In act 514, the index engine creates points for each selected piece of media and a segment associated with the event, stores the points and the segment in the media index, and terminates the process 500. In at least one embodiment, the index engine executes the createMediaQ, createPoint( ), pairPointAndMedia( ), and createSegment( ) functions to create the points and the segment in a media index, such as the media index 122. In some embodiments, the index engine stores information descriptive of the event (e.g. the predetermined range of dates, associations generated by the event, etc.) within the newly created segment, or elsewhere. In these embodiments, the index engine may query the user for at least part of the event information (e.g. title or description) via a user interface, such as the user interface 116.

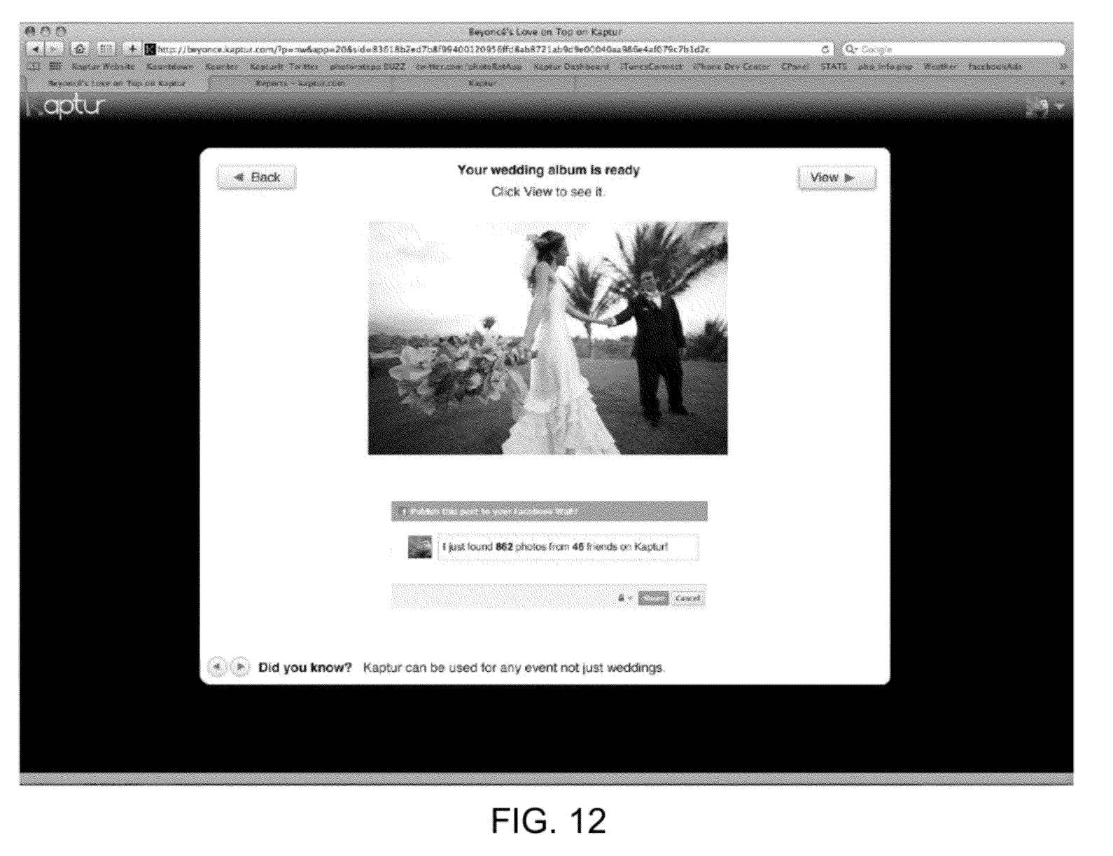

FIG. 12 shows an exemplary screen presented by the user interface after completion of the act 514. As shown in FIG. 12, the screen includes an element labeled “View” that, when actuated, causes the user interface to navigate to a view of the newly created segment.

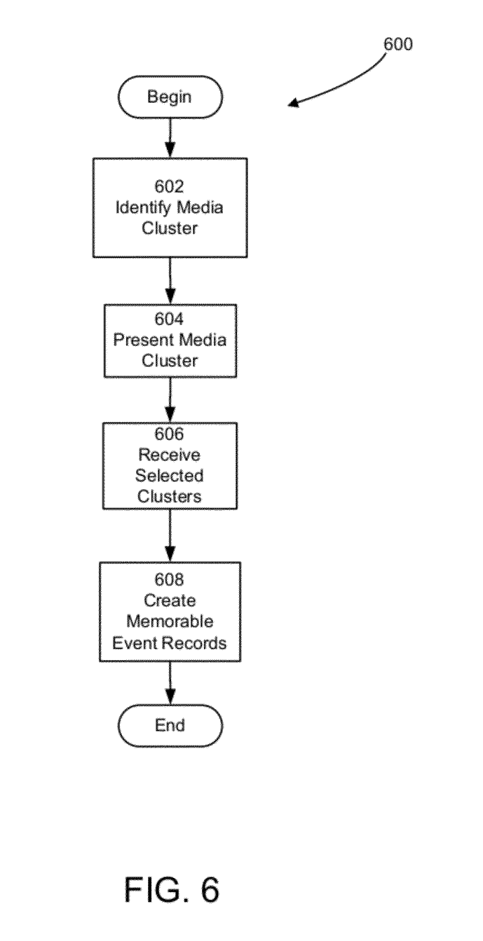

Other embodiments perform processes that discover memorable events based on media information stored in a media index. In some of these embodiments, an index engine, such as the index engine 120, includes a memorable events discovery component configured to execute these processes. One example of a memorable events discovery process that can be executed by the memorable events discovery component is illustrated in FIG. 6. According to this example, the memorable events discovery process 600 includes acts of identifying a media cluster, presenting identified media clusters via a user interface, receiving selected clusters and creating records of memorable events.

In act 602, the media organization system identifies, via an index engine such as the index engine 120, one or more clusters of media associated with a user that are stored within a media index, such as the media index 122, or within one or more target websites. In some embodiments, each cluster must possess a requisite “density.” Density may be measured by a number of factors including the number of users associated with pieces of media, the number of pieces of media (or associated users) contained within a predetermined range of dates, or the number of pieces of media (or associated users) associated with locations within a predetermined geographical area. In these embodiments, the range, the area, the number of associated users and the threshold number of points are configurable parameters.

In embodiments configured to utilize a media index within the act 602, the index engine scans the media index for clusters of media that possess the requisite density, (e.g. that include more than a threshold number of points that fall within a range or area of a central point). In these embodiments, the index engine may execute functions including getPointsByUsersAndTime( ), getPointsByUsersAndLocation( ), and getPointsByTimeAndLocation( ). In embodiments configured to utilize one or more target websites within the act 602, the index engine authenticates, via a system interface such as the system interface 118, the media organization system with each target website, requests media stored on each target website that is associated with the user and that was created by any member of a predetermined set of users, and identifies clusters with the requisite density. In these embodiments, the predetermined set of users is a configurable parameter.

It is to be appreciated that embodiments may be configured to utilize both a media index and one or more target websites to build a set of media that is scanned for clusters having the requisite density and embodiments are not limited to using solely the media index or the one or more target websites for sources of media.

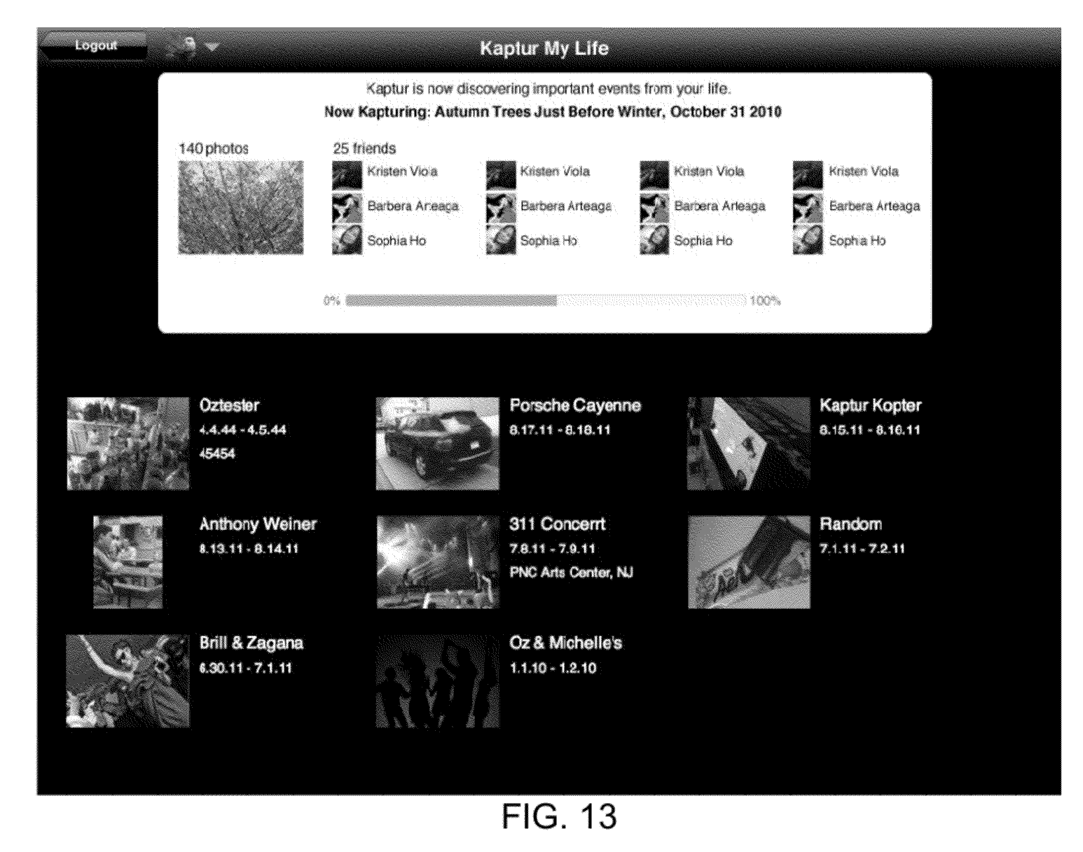

Next, in act 604, the media organization system presents, via the index engine, the one or more identified clusters to the user via a user interface, such as the user interface 116. FIG. 13 illustrates an exemplary screen presented by the user interface in the act 604. As shown in FIG. 13, the screen includes an element labeled “Now Kapturing” that displays a currently identified cluster.

In act 606, the media organization system receives and stores, from the user via the user interface, a set of selected clusters identified as having media depicting memorable events. FIG. 13 also illustrates an exemplary screen presented by the user interface in the act 606. As shown in FIG. 13, the screen includes elements labeled “Oztester,” “Porsche Cayenne,” etc. that, when actuated, cause the user interface to select the memorable event represented by the label. In act 608, the media organization system creates, via the index engine, points or segments to associate with the selected memorable events, stores the points or the segments in the media index and terminates the process 600. In at least one embodiment, the index engine executes the createMedia( ), createPoint( ), pairPointAndMedia( ), or createSegment( ) functions to create the points or the segments in a media index. In some embodiments, the index engine stores information descriptive of the memorable event (e.g. the range, the area, the threshold number of points or pieces of media, the predetermine set of users, etc.) within the newly created segment or elsewhere. In these embodiments, the index engine may query the user for at least part of the event information (e.g. title or description) via a user interface, such as the user interface 116.

According to some embodiments, the media organization system executes the process 600 each time a user, such as the user 102, logs onto the media organization system. In these embodiments, the process 600 searches for clusters having a central point falling beyond the last recorded memorable event, thereby limiting the search to potentially new memorable events.

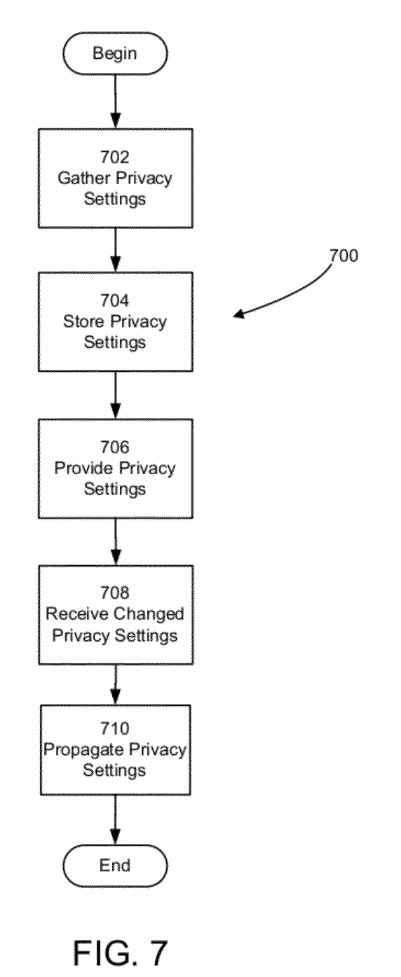

Other embodiments perform processes that centrally manage privacy settings for a plurality of websites. One example of such a privacy settings management process is illustrated in FIG. 7. According to this example, the privacy setting management process 700 includes acts of gathering privacy settings from a plurality of websites, storing the gathered privacy settings, providing the privacy settings to a user interface, receiving changed privacy settings from the user interface, and propagating the changes to the plurality of websites.

In act 702, the media organization system gathers privacy settings from each of a one or more of websites. In some embodiments, the media organization system gathers these privacy settings by executing a plurality of API calls to the websites via a system interface, such as the system interface 118. Responsive to receiving current privacy settings from each of the plurality of websites, in act 704 the media organization system stores the current privacy settings within a data storage, such as the user services data storage 124.

In act 706, the media organization system provides the current privacy settings to a user interface, such as the user interface 116. Next, in act 708, the media organization system receives changed privacy settings from the user interface and stores the changed privacy settings. In act 710, the media organization system provides the changed privacy settings to the websites and terminates the process 700. In some embodiments, the media organization system provides the changed privacy setting to the websites by executing a plurality of API calls to the websites via the system interface.

### Usage Scenario

An example usage scenario demonstrating the capabilities of the embodiments disclosed herein will now be discussed with reference to FIG. 1. In this example, the user 102 uses the computer system 104 to upload a set of videos to the website 106, upload a set of photographs to the website 108 and tweet about three different events captured by the uploaded media on the website 110. In this example, the three events occurred on March 12, August 8 and October 31.

Next, the user 102 creates an account on the media organization system 112 via an application executing on the computer system 104 and the user interface 116. The user 102 also enters authentication credentials for each of the websites 106, 108, and 110. In response to receipt of the authentication credentials, the media organization system 112 creates a user account for the user 102 and uses the authentication credentials to discover the set of videos, the set of photographs, and the tweets. The media organization system 112 stores references to the videos, photographs and tweets within the media index 122.

Next, the media organization system 112 provides, via the user interface 116 and the computer system 104, a prompt to the user 102 requesting a date of an event of importance to the user 102. The user 102 responds to the prompt by entering the date of March 12. In response to receiving the date, the media organization system 112 scans, via the system interface 118, the websites 106, 108, and 110 for media created within a predetermined or configurable period of time (e.g., two days) of March 12 by the user and any other users associated with the user within the websites 106, 108, and 110. Then the media organization system 112 provides, via the user interface 116 and the computer system 104, a representation of other users associated with any media discovered by the scanning activity.

Next, the user 102 selects a set of other users from the representation of the users provided by the media organization system 112. In response to receiving the selected set of users, the media organization system 112 displays, via the user interface 116, discovered media associated with the user that is owned by the user or by the selected set of users. The user 102 then selects a set of media as depicting the event of March 12.

In response to receiving the selected set of media, the media organization system 112 creates references within the media index 122 that associate the selected set of media with an event. Then, the media organization system 112 provides a representation of the event to the user via the user interface 116 and the computer system 104.

Next, the media organization system 112 scans the media index 122 for clusters of media that include some minimum number of pieces of media (e.g., at least 10 pieces of media) associated with the user 102 and that were created within a range of 2 days. During this process, the media organization system 112 determines that two clusters associated with the user exist near August 8 and October 31.

In response to making this determination, the media organization system 112 provides, via the user interface 116 and the computer system 104, selectable representations of the two clusters to the user 102. In response to receiving an indication that the user 102 has selected the selectable representation of October 31, the media organization system 112 scans, via the system interface 118, or the websites 106, 108, and 110 for media created within two days of October 31 by the user and any other users associated with the user. Then the media organization system 112 provides, via the user interface 116 and the computer system 104, a representation of other users associated with any media discovered by the scanning activity. While in this example, the media organization system 112 scans the websites for media associated with other users, in other examples, the media organization system scans the media index 122 for the media associated with other users. In other examples, the media organization system 112 may scan the websites for media while scanning the media index 122 or before scanning the media index 112. Additionally, the media organization system 112 may scan the websites for media owned by a limited number of users. Thus embodiments of the media organization system 112 are not limited to particular relationships or orders of scanning when determining the existence of clusters of media.

Next, the user 102 selects a set of other users from the representation of the other users provided by the media organization system 112. In response to receiving the selected set of other users, the media organization system 112 creates references within the media index 122 that associate the discovered media owned by the users with an event and associates the previously stored references to the user's uploaded media with the event. Then, the media organization system 112 provides a representation of the event to the user via the user interface 116 and the computer system 104.

### Alternative Embodiments

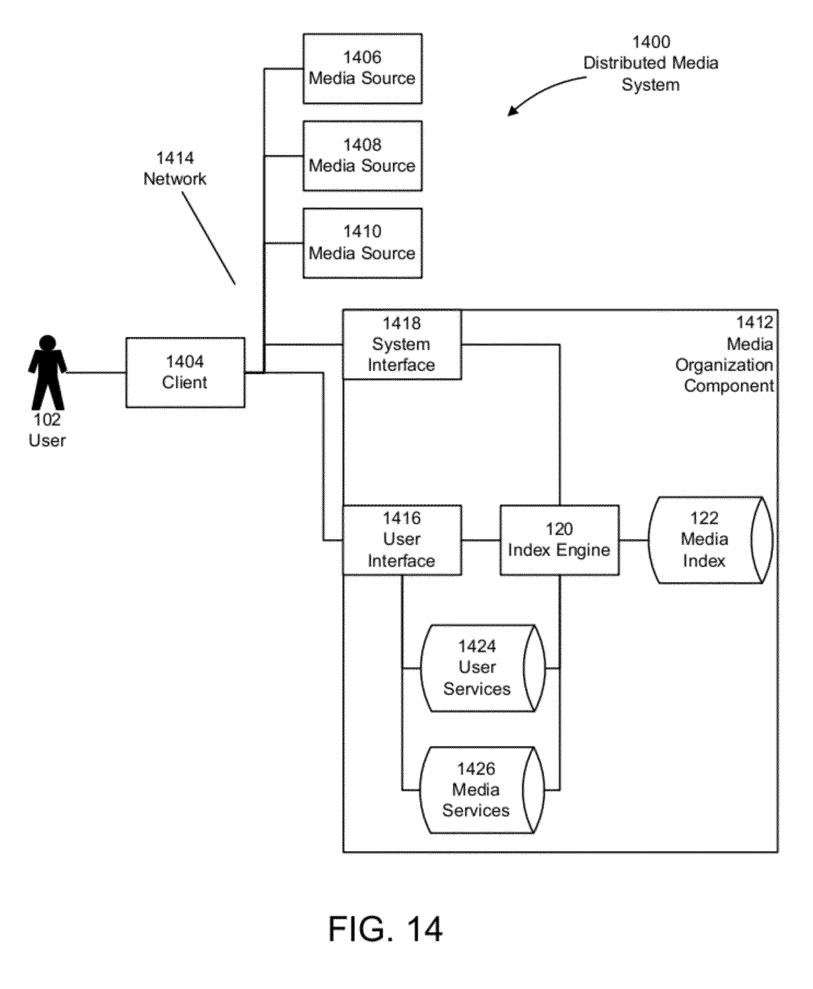

In alternative embodiments, a media organization component identifies, normalizes, and manages media assets and accounts across sources of media other than websites. These sources of media (“media sources”) may include any type of data storage capable of storing media or any device including data storage. Examples of media sources include physical storage devices, such as computer hard drives, mobile computing devices, data storage provided by cloud services, storage accessed via email services, etc. Further, these alternative embodiments identify events of interest to users and discover media associated with these events. FIG. 14 illustrates an exemplary media system 1400 including one of these alternative embodiments. Many of the components illustrated in FIG. 14 comprise structure and function similar to those components described above with reference to FIG. 1. In the interest of brevity, many of these similarities will not be redundantly addressed with reference to FIG. 14. As shown, FIG. 14 includes a user 102, a client 1404, media sources 1406, 1408, and 1410, a media organization component 1412, and a communication network 1414.

As illustrated in FIG. 14, the client 1404, the media sources 1406, 1408, and 1410, and the media organization component 1412 exchange (i.e. send or receive) information via the network 1414. For instance, the client 1404 may exchange information with the media organization component 1412 or the media sources 1406, 1408, and 1410 through the network 1414. Similarly, the media organization component 1412 may exchange information with the media sources 1406, 1408, and 1410 through the network 1414. The network 1414 may include any communication network through which computer systems or computer system components exchange information.

In some embodiments where the media system 1400 is a distributed computer system, the client 1404 and the media sources 1406, 1408, and 1410 are each implemented using a separate computer system, such as the computer system described above with reference to FIG. 2. In these embodiments, the network 1414 may be a public network, such as the internet, and may include other public or private networks such as LANs, WANs, extranets, and intranets.

In some embodiments where the media system 1400 resides within a single computer system, the client 1404 and the media sources 1406, 1408, and 1410 are each implemented using software components, hardware components or a combination thereof. In these embodiments, the network 1414 may be an interconnection element such as the bus 214 describe above with reference to FIG. 2.

In the embodiment illustrated in FIG. 14, the media organization component 1412 includes several components: a user interface 1416, a system interface 1418, an index engine 120, a media index data storage (“media index”) 122, a user services data storage 1424, and a media services data storage 1426. As described above with reference to FIG. 1, the media index 122 includes a variety of data structures and data elements including both points and segments. Although depicted as being stored in separate storage locations, the media index 122, the user services data storage 1424, and the media service data storage 1426 may be stored on the same physical storage medium.

The user services data storage 1424 includes a variety of data structures and data elements used by the media organization component 1412 to normalize user accounts, such as those associated with the user 102, across one or more media sources, such as the media sources 1406, 1408, and 1410. According to one embodiment, the user services data storage 1424 includes a table with each row representing a discrete user. The data structure of each row includes a user identifier field, a service identifier field, an authentication credentials field, and a privacy settings field. The user identifier field stores information that indicates an identifier of a user of the media organization component 1412, such as the user 102. The information within the user identifier field may be encoded in a variety of formats, including a dynamically generated unique integer or alphanumeric string associated with the user. The service identifier field stores information that indicates a media source that stores media to which the user has access. The information within the service identifier field may be encoded in various formats, including a text string identifying the media source. The authentication credentials field stores information that indicates a set of authentication credentials associated with the user through which access to the user's account on the media source indicated in the service field identifier may be granted. The information within the authentication credentials field may be encoded in various formats, including a text string indicative of a user logon and password for the media source. In some examples, the user services data storage 1424 stores the user's authentication credentials for all of the media sources storing media associated with the user. The privacy settings field stores information that indicates privacy settings of the user for the media source indicated in the service field identifier. The information within the user identifier field may be encoded in a variety of formats as required to support the privacy settings made available by the media source indicated in the service field identifier.

The media services data storage 1426 includes a variety of data structures and data elements used by the media organization component 1412 to normalize media associated with a user, such as those associated with the user 102, across one or more media sources, such as the media sources 1406, 1408, and 1410. According to one embodiment, the media services data storage 1426 includes a table with each row representing a discrete piece of media. The data structure of each row includes a media identifier field, a time stamp field, a location identifier field, an owner identifier field, a service identifier field, and a service metadata field. The media identifier field stores information that identifies a piece of media within the media organization component 1412. The information within the media identifier field may be encoded in sundry formats, including a dynamically generated unique integer or alphanumeric string value associated with the media. The time stamp field stores information that indicates a date and time that the piece of media was created or dated. The information within the time stamp field may be encoded in a variety of formats, including in Universal Time Code (“UTC”) time. The location identifier field stores information that indicates a geographic location associated with the piece of media, such as where the media was created. The information within the location identifier field may be encoded in various formats, including a set of global positioning system (“GPS”) coordinates or a free-form text string indicative of a geographic location. The owner identifier field stores information that identifies a position of user information within the user services data storage 1424. The information within the user identifier field may be encoded in any of several formats, including an integer or alphanumeric string value indicative of a position within the user services data storage 1424. The service identifier field stores information that indicates a media source that stores the media. The information within the service identifier field may be encoded in various formats, including a text string identifying the media source. The service metadata field stores information that indicates an address of the piece of media within the media source. The information within the service metadata field may be encoded in a number of formats, including location identifier associated with the media as stored in the media source. In some embodiments, the data structure of the media service data storage 1426 includes additional fields that store metadata made available by the media source storing the piece of media.

Information within the media system 1400, including data within the media index 122, the user services data storage 1424, and the media services data storage 1426 may be stored in any logical construction capable of holding information on a computer readable medium including, among other structures, file systems, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance. In some embodiments, the owner identifier fields and the media identifier fields within the media index 122 are foreign keys linked to corresponding fields within the user services data storage 1424 and the media services data storage 1426.

Returning to the example illustrated in FIG. 14, the user interface 1416 is configured to interact with the user 102 via the network 1414 and the client 1404. The user interface 1416 may employ a variety of metaphors and user interface elements to provide and receive information. Particular embodiments of the user interface 1416 are not limited to any one metaphor or configuration of user interface elements. For instance, in one embodiment where the media system 1400 is implemented using a distributed computer system, the user interface 1416 serves a browser-based user interface to the user 102 that is rendered by a web-browser running on the client 1404. In another embodiment where the media system 1400 is implemented using a single computer system, the user interface 1416 includes a web-server or other server program and the client 1404 is a web-browser or other client program that renders information to the user 102. The user interface 1416 exchanges a variety of information with the user 102. This information may include any of the information described above with reference to the media index 122, the user services data storage 1424, and the media services data storage 1426.

As illustrated in FIG. 14, the system interface 118 is configured to interact with the client 104 and the media sources 1406, 1408, and 1410 via the network 1414. The system interface 1418 may employ a variety of protocols to exchange information with the client 1404 and the media sources 1406, 1408, and 1410. For instance, in one embodiment, the system interface 1418 communicates with the client 1404 and the media sources 1406, 1408, and 1410 using hypertext transfer protocol (“HTTP”). The system interface 1418 exchanges a variety of information with the client 1404 and the media sources 1406, 1408, and 1410. This information may include any of the information described above with reference to the media index 122, the user services data storage 1424, and the media services data storage 1426.

In some examples, applications executing on the client 1404 access and manage media stored on the media sources 1406, 1408, and 1410 by exchanging information with the system interface 1418. In these examples, the system interface 118 communicates with both the index engine 120 and the media sources 1406, 1408, and 1410 to process information provided by the applications executing on the client 1404. While exchanging information with applications running on the client 1404 and the media sources 1406, 1408, and 1410, the system interface 1418 executes API calls to the index engine 120. The API calls executed by the system interface 1418 may include any API call supported by the index engine 120 described above.

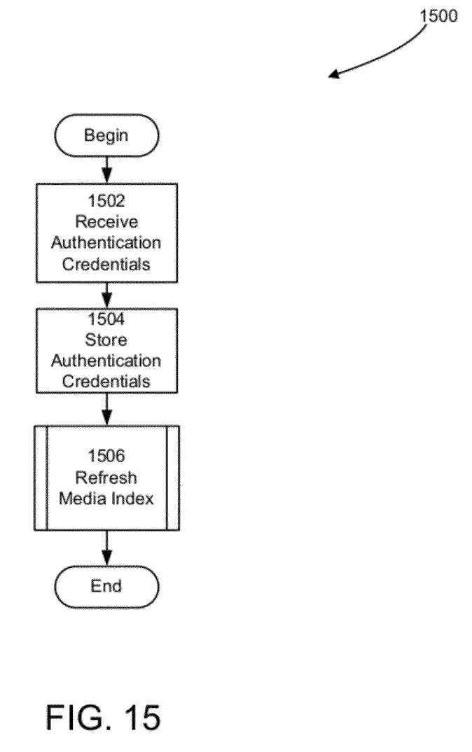

In other embodiments, the index engine 120 performs additional processes via additional components. In some of these embodiments, the index engine 120 loads and executes an alternative event discovery component. In others of these embodiments, the index engine 120 loads and executes an alternative memorable events discovery component. In still other embodiments, the index engine 120 loads and executes an alternative refresh component. These components and other processes executed by the index engine 120 are described further below with reference to FIGS. 15-18.

Embodiments disclosed herein are not limited to the particular configuration illustrated in FIG. 14. Various embodiments utilize a variety of hardware components, software components and combinations of hardware and software components configured to perform the processes and functions described herein. For instance, in at least one embodiment, the client 1404 is implemented using a computer system, such as the computer systems described below with reference to FIG. 2.

### Alternative Media Organization Processes

According to one example illustrated by FIG. 14, the user 102 interacts with the client 1404 to provide media to various media sources including the media sources 1406, 1408, and 1410. Examples of this media include photographs, videos, text messages, tweets, and status updates. Each of the media sources 1406, 1408, and 1410 stores the media provided by the user 102 and media provided by other users. In addition, each of the media sources 1406, 1408, and 1410 stores metadata associated with the media. This metadata may include commentary describing the media, information describing the quality of the media, and information identifying characteristics depicted in the media.

According to some embodiments, a media organization component, such as the media organization component 1412 describe above with reference to FIG. 14, performs processes that discover media associated with a user. One example of such a process is illustrated in FIG. 15. According to this example, a process 1500 includes acts of receiving authentication credentials, storing the authentication credentials, and refreshing a media index.

In act 1502, the media organization component receives a set of authentication credentials for a user. In at least one embodiment, the set of authentication credentials is received via a user interface, such as the user interface 1416 described above with reference to FIG. 14. The set of authentication credentials may include a user logon and password for one or more media sources that store media associated with the user.

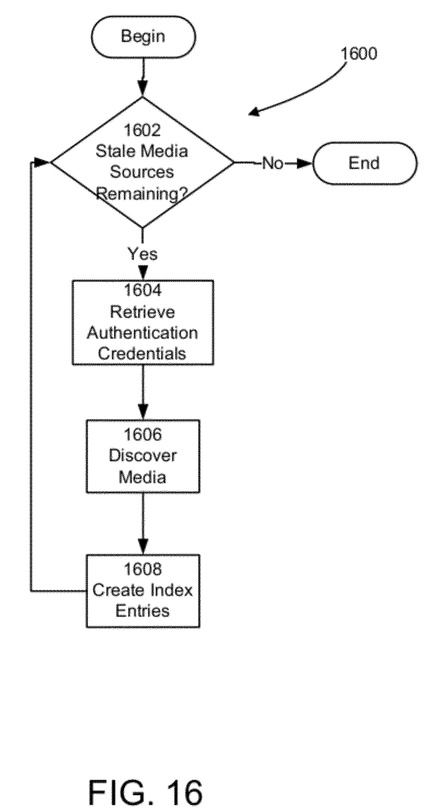

In act 1504, the media organization component stores the set of authentication credentials in a data storage, such as the user services data storage 1424. Next, in act 1506, the media organization component refreshes its media index. In at least one embodiment, an index engine of the media organization component, such as the index engine 120, refreshes a media index, such as the media index 122 by executing an alternative refresh process. This refresh process is described further below with reference to FIG. 16. Upon completion of the act 1506, the media organization component terminates the process 1500.

Processes such as the process 1500 enable a media organization component maintain a current set of references to media recently provided by its users.

Other embodiments perform processes that refresh a media index based on newly discovered media information. In some of these embodiments, an index engine, such as the index engine 120, includes an alternative refresh component configured to execute these processes. One example of an alternative refresh process that can be executed by the alternative refresh component is illustrated in FIG. 16. According to this example, the alternative refresh process 1600 includes acts of determining whether stale media sources remain unprocessed, retrieving authentication credentials, discovering media and creating index entries.

In act 1602, the media organization component determines whether any stale media sources remain unprocessed. According to some embodiments, an index engine, such as the index engine 120, make this determination for the media organization component by retrieving a time stamp of a previous attempt to discover media on the target site from the media services data storage 1426. In these embodiments, the index engine deems a target media source as stale where a threshold period of time, for example two days, has elapsed since the previous attempt. In some embodiments, this threshold period of time is a configurable parameter. If no stale media sources remain unprocessed, the index engine terminates the process 1600. Otherwise, the index engine retrieves authentication credentials for the next target media source in act 1604.

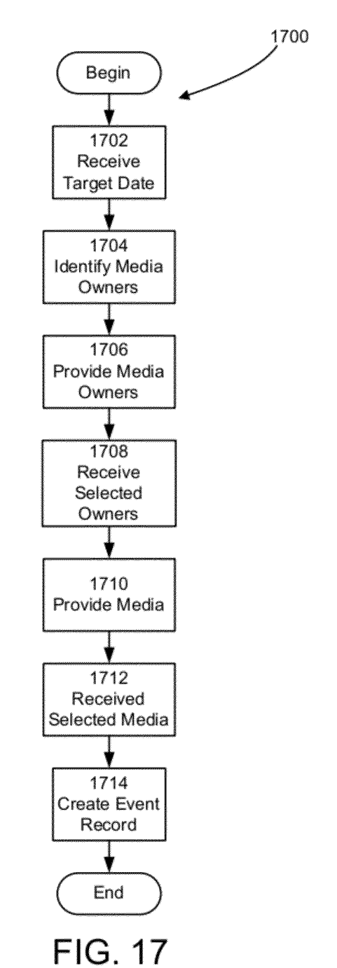

Next, in act 1606, the index engine uses the authentication credentials to discover any media that meets a set of search criteria and that is stored on the target media source. In some embodiments, this search criteria may require that the media be associated with the user or an event. In at least one embodiment, the index engine, via a system interface such as the system interface 1418, first authenticates the media organization component with the target media source using the authentication credentials of the user. It is to be appreciated that some target media sources may authenticate based solely on identification, (for example, some target media sources may allow access to media information when presented with an identifier of a user without an accompanying password). Next, the index engine requests media associated with the user by issuing requests to the target media source in a format subscribing to the requirements of the target media source. In at least some embodiments, which are described further below with reference to FIG. 17, the index engine requests media associated with a specific event (i.e., media dated within a predetermined range of time or associated with particular users other than the currently authenticated user).

In response to the requests for media, the target media source provides media information associated with the user. This media information may include both media associated with the user and metadata describing the media, such as comments or tags associated with the media that reference the user. The index engine receives this media information via the system interface.

Media associated with the user may be media provided to the media sources and “owned” by the user. Media associated with the user may also include media provided to the media sources and “owned” by others. For instance, in one embodiment, the index engine associates some pieces of media provided by others may be associated with the user by virtue of the user being associated with the other users on a media source. Various media sources may determine associations between the user and other users using a variety of techniques. For instance, media sources may associate the user with other users who are “friends” of the user, who are engaged in a “following” relationship with the user, who share media with the user, who share the same computer system, who are within circles managed by the user, or who in within the same circles as the user.

In some embodiments, the index engine associates other pieces of media with the user by virtue of the media being tagged with an identifier of the user. In other embodiments, the index engine associates other pieces of media with the user by virtue of the media being associated with a comment that includes an identifier of the user. The index engine may execute the pairPointWithUser( ) to store these associations.

In some embodiments, the index engine further establishes associations between users that are not recognized within a websites. In these embodiments, the index engine associates to users who have associations with a common piece of media, regardless of whether the users are associated within a website. Actions performed by the index engine to establish these associations include scanning the media index to find pieces of media associated with more than one user and associating the users found by the scanning process.

In act 1608, the index engine creates index entries, such as points or segments, within the media index for any newly discovered or changed media and then executes the act 1602. For example, in one embodiment, the index engine executes the createMedia( ) function to create a new entry in the media services data storage 1426 for each piece of discovered media, executes the createPoint( ) function to create a new point in the media index 122 for each piece of discovered media, and executes the pairPointAndMedia( ) function to associate the new points with the new entries in a one-to-one manner. Further, the index engine may execute the createSegment( ) function to create a segment including a range of points.

In at least one embodiment, the index engine also downloads, via the system interface, the newly discovered pieces of media to local data storage, such as the media services data storage 126. In this embodiment, the media organization component is able to provide downloaded media to the user via the user interface in an off-line mode, i.e. when the media organization component is not connected to the internet.

Upon completion of the process 1600, the media organization component may provide newly discovered media to a user via a user interface, such as the user interface 1416. In some embodiments, the user interface provides both newly discovered and known media according the privacy settings currently in force on each media source. Processes such as the process 1600 enable the media organization component to act as a central administrator of media stored on a plurality of media sources. Through its system and user interfaces, the media organization component may be used by both systems and users to access and control media stored within multiple media sources.

Other embodiments perform processes that discover events associated with media stored on one or more target media sources. Some of these processes discover events based on identification information entered by a user. Further, in some embodiments, an index engine, such as the index engine 120, includes an alternative event discovery component configured to execute the processes. One example of a process that can be executed by the alternative event discovery component is illustrated in FIG. 17. According to this example, the alternative event discovery process 1700 includes several acts that are described further below.

In act 1702, the media organization component receives and stores, via an interface, such as the user interface 1416 or the system interface 1418, a target date of an event from an external entity, such as a user or a computer system, interested in organizing media depicting the event within the media organization component.

Next, in act 1704, the media organization component identifies, on each target media source, media associated with the interested user that is dated with a date falling within a predetermined range, for example 5 days, of the target date of the event. The media organization component may also identify users who own the associated media. In illustrated embodiment, the media organization component performs this identification by executing an index engine, such as the index engine 120, and the predetermined range used by the index engine is a configurable parameter. More particularly, in the act 1704, the index engine authenticates, via a system interface such as the system interface 1418, the media organization component with each target media source, requests media stored on each target media source that is associated with the interested user and that is dated with a date falling within the predetermined date range, and identifies the associated users who own any media returned by the media sources.

In act 1706, the index engine presents any identified users to the interested user via the user interface. Next, in act 1708, the index engine receives and stores, from the interested user via the user interface, a set of selected users identified as having media depicting the event. In response to receiving the set of selected users, the index engine stores an association between the selected users and the interested user and an association between the selected users and the event. In some embodiments, these associations are stored in conjunction with points and segments in the media index. These associations may be later used to “refresh” the media associated with the event, where, for example, the selected users upload additional media depicting the event after the event is initially discovered via execution of the process 1700. In this way, when executing a refresh process for a previously recorded event, the index engine may use the target date (or the date range) and the selected users from the previously recorded event to gather media from the media sources, rather than redundantly querying the user for a previously specified target date and selected users.

In act 1710, the index engine presents, via the user interface, representations of the pieces of media associated with the identified users and representations of the media associated with the interested user that is dated with a date falling within the predetermined range of the target date.

In act 1712, the index engine receives and stores, from the interested user via the user interface, a set of selected pieces of media identified as depicting the event. Next, in act 1714, the index engine creates points for each selected piece of media and a segment associated with the event, stores the points and the segment in the media index, and terminates the process 1700. In at least one embodiment, the index engine executes the createMedia( ), createPoint( ), pairPointAndMedia( ), and createSegment( ) functions to create the points and the segment in a media index, such as the media index 122. In some embodiments, the index engine stores information descriptive of the event (e.g. the predetermined range of dates, associations generated by the event, etc.) within the newly created segment, or elsewhere. In these embodiments, the index engine may query the user for at least part of the event information (e.g. title or description) via a user interface, such as the user interface 1416.

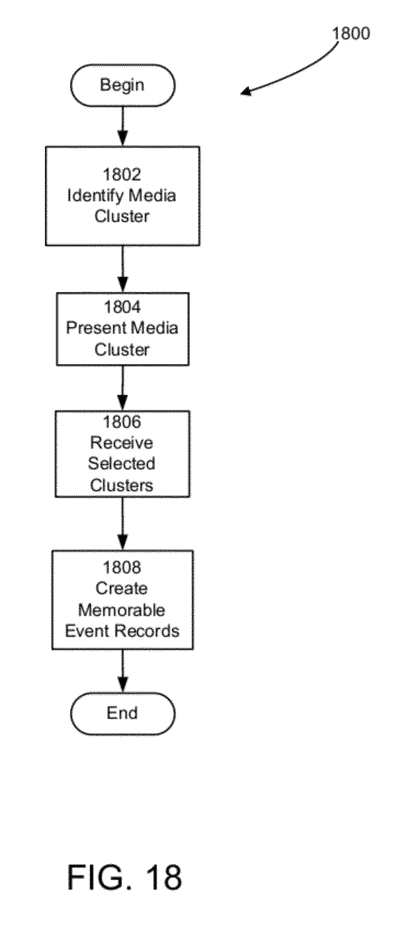

Other embodiments perform processes that discover memorable events based on media information stored in a media index. In some of these embodiments, an index engine, such as the index engine 120, includes an alternative memorable events discovery component configured to execute these processes. One example of an alternative memorable events discovery process that can be executed by the memorable events discovery component is illustrated in FIG. 18. According to this example, the alternative memorable events discovery process 1800 includes acts of identifying a media cluster, presenting identified media clusters via a user interface, receiving selected clusters and creating records of memorable events.

In act 1802, the media organization component identifies, via an index engine such as the index engine 120, one or more clusters of media associated with a user that are stored within a media index, such as the media index 122, or within one or more target media sources. In some embodiments, each cluster must possess a requisite “density.” Density may be measured by a number of factors including the number of users associated with pieces of media, the number of pieces of media (or associated users) contained within a predetermined range of dates, or the number of pieces of media (or associated users) associated with locations within a predetermined geographical area. In these embodiments, the range, the area, the number of associated users and the threshold number of points are configurable parameters.

In embodiments configured to utilize a media index within the act 1802, the index engine scans the media index for clusters of media possess the requisite density, (e.g., that include more than a threshold number of points that fall within a range or area of a central point). In these embodiments, the index engine may execute functions including getPointsByUsersAndTime( ), getPointsByUsersAndLocation( ), and to getPointsByTimeAndLocation( ). In embodiments configured to utilize one or more target media sources within the act 1802, the index engine authenticates, via a system interface such as the system interface 1418, the media organization component with each target media source, requests media stored on each target media source that is associated with the user and that was created by any member of a predetermined set of users, and identifies clusters with the requisite density. In these embodiments, the predetermined set of users is a configurable parameter.

It is to be appreciated that embodiments may be configured to utilize both a media index and one or more target media sources to build a set of media that is scanned for clusters having the requisite density and embodiments are not limited to using solely the media index or the one or more target media sources for sources of media.

Next, in act 1804, the media organization component presents, via the index engine, the one or more identified clusters to the user via a user interface, such as the user interface 1416. In act 1806, the media organization component receives and stores, from the user via the user interface, a set of selected clusters identified as having media depicting memorable events.

In act 608, the media organization component creates, via the index engine, points or segments to associate with the selected memorable events, stores the points or the segments in the media index, and terminates the process 600. In at least one embodiment, the index engine executes the createMedia( ), createPoint( ), pairPointAndMedia( ), or createSegment( ) functions to create the points or the segments in a media index. In some embodiments, the index engine stores information descriptive of the memorable event (e.g. the range, the area, the threshold number of points or pieces of media, the predetermine set of users, etc.) within the newly created segment or elsewhere. In these embodiments, the index engine may query the user for at least part of the event information (e.g. title or description) via a user interface, such as the user interface 1416.

According to some embodiments, the media organization component executes the process 1800 each time a user, such as the user 102, logs onto the media organization component. In these embodiments, the process 1800 searches for clusters having a central point falling beyond the last recorded memorable event, thereby limiting the search to potentially new memorable events.

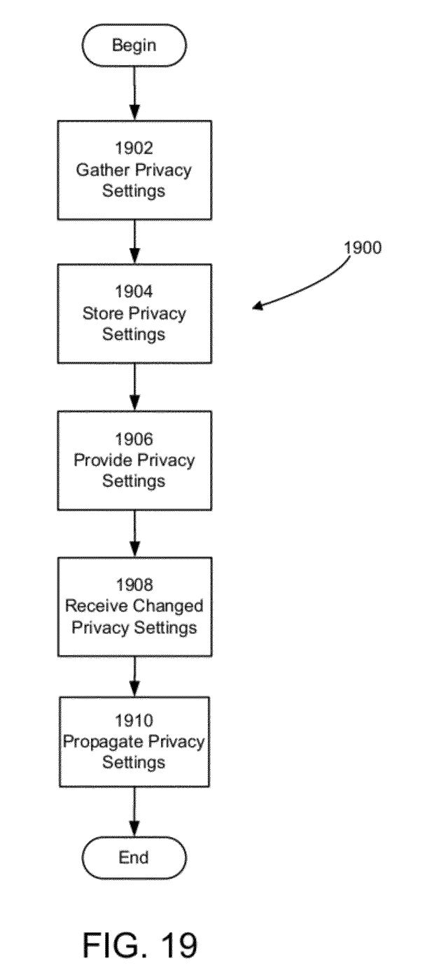

Other embodiments perform processes that centrally manage privacy settings for a plurality of media sources. One example of such a privacy settings management process is illustrated in FIG. 19. According to this example, the privacy setting management process 1900 includes acts of gathering privacy settings from a plurality of media sources, storing the gathered privacy settings, providing the privacy settings to a user interface, receiving changed privacy settings from the user interface, and propagating the changes to the plurality of media sources.

In act 1902, the media organization component gathers privacy settings from each of a one or more of media sources. In some embodiments, the media organization component gathers these privacy settings by executing a plurality of calls to the media sources via a system interface, such as the system interface 1418. Responsive to receiving current privacy settings from each of the plurality of media sources, in act 1904 the media organization component stores the current privacy settings within a data storage, such as the user services data storage 1424.

In act 1906, the media organization component provides the current privacy settings to a user interface, such as the user interface 1416. Next, in act 1908, the media organization component receives changed privacy settings from the user interface and stores the changed privacy settings. In act 1910, the media organization component provides the changed privacy settings to the media sources, and terminates the process 1900. In some embodiments, the media organization component provides the changed privacy setting to the media sources by executing a plurality of calls to the media sources via the system interface.

Processes 400 through 700 and 1500 through 1900 each depict one particular sequence of acts in a particular example. The acts included in these processes may be performed by, or using, one or more computer systems specially configured as discussed herein. Some acts are optional and, as such, may be omitted in accord with one or more examples. Additionally, the order of acts can be altered, or other acts can be added, without departing from the scope of the systems and methods discussed herein. Furthermore, as discussed above, in at least one example, the acts are performed on a particular, specially configured machine, namely a computer system configured according to the examples and embodiments disclosed herein.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system for organizing media across a plurality of websites, the system comprising:
a memory;
at least one processor in data communication with the memory; and
an index component executed by the at least one processor and configured to:
receive a set of authentication credentials, each member of the set of authentication credentials corresponding to a respective website of the plurality of websites;
execute a plurality of application program interface (API) calls, each API call of the plurality of API calls corresponding to a respective website of the plurality of websites, at least one API call of the plurality of API calls using a member of the set of authentication credentials;
receive a set of media information from at least one of the plurality of websites, each member of the set of media information corresponding to a respective piece of media of a plurality of pieces of media; and
store a plurality of point representations within the memory, each of the plurality of point representations corresponding to, and associated with, a respective piece of media of the plurality of pieces of media.

2. The system according to claim 1, wherein some of the plurality of API calls correspond to at least one of Facebook, Twitter, Google, Foursquare, and Flickr.

3. The system according to claim 1, wherein the plurality of pieces of media include at least one of a photograph, a video, and text data.

4. The system according to claim 1, wherein the index component is further configured to associate at least one of a time stamp, a location identifier, a media identifier and an owner identifier with each of the plurality of point representations.

5. The system according to claim 1, wherein the index component is further configured to store at least one segment representation with in the memory, the at least one segment representation corresponding to at least two of the plurality of point representations.

6. The system according to claim 5, wherein the index component is further configured to associate at least one of a start time, an end time, a title, a description, a thumbnail image, an owner identifier, and a location identifier with the at least one segment representation.

7. The system according to claim 5, wherein the index component is further configured to provide a representation of the at least one segment representation to a user interface.

8. The system according to claim 1, further comprising an event discovery component executed by the processor and configured to:
to receive a target date via an interface;
determine at least one owner identifier associated with media information dated within a range of the target date;
present, via the interface, a representation of at least one owner corresponding to the at least one owner identifier;
receive at least one selected owner selected via the interface;
present, via the interface, at least one piece of media of the plurality of pieces of media, the at least one piece of media being associated with an owner identifier corresponding to the at least one selected owner;
receive at least one selected piece of media selected via the interface; and
store at least one event representation within the memory, the event representation corresponding to, and associated with, the target date, the at least one selected owner, and the at least one selected piece of media.

9. The system according to claim 8, wherein the at least one event representation includes a segment representation.

10. The system according to claim 1, further comprising a memorable events discovery component executed by the processor and configured to:
identify at least one cluster of media information dated within a range of a central date; and
present, via the interface, a representation of the at least one cluster.

11. The system according to claim 10, wherein the at least one cluster includes a segment representation.

12. A method for organizing media across a plurality of websites, the method comprising:
receiving a set of authentication credentials, each member of the set of authentication credentials corresponding to a respective website of the plurality of websites;
executing a plurality of API calls, each API call of the plurality of API calls corresponding to a respective website of the plurality of websites, at least one API call of the plurality of API calls using a member of the set of authentication credentials;
receiving a set of media information from at least one of the plurality of websites, each member of the set of media information corresponding to a respective piece of media of a plurality of pieces of media; and
storing a plurality of point representations within the memory, each of the plurality of point representations corresponding to, and associated with, a respective piece of media of the plurality of pieces of media.

13. The method according to claim 12, wherein executing the plurality of API calls comprises executing an API call corresponding to at least one of Facebook, Twitter, Google, Foursquare, and Flickr.

14. The method according to claim 12, further comprising:
receiving a target date via an interface;
determining at least one owner identifier associated with media information dated within a range of the target date;
presenting, via the interface, a representation of at least one owner corresponding to the at least one owner identifier;
receiving at least one selected owner selected via the interface;
presenting, via the interface, at least one piece of media of the plurality of pieces of media, the at least one piece of media being associated with an owner identifier corresponding to the at least one selected owner;
receiving at least one selected piece of media selected via the interface; and
storing at least one event representation within the memory, the event representation corresponding to, and associated with, the target date, the at least one selected owner, and the at least one selected piece of media.

15. The method according to claim 14, wherein storing the at least one event representation includes storing a segment representation.

16. The method according to claim 12, further comprising:
identifying at least one cluster of media information dated within a range of a central to date; and
presenting, via the interface, a representation of the at least one cluster.

17. The method according to claim 10, wherein identifying the at least one cluster includes identifying a segment representation.

18. A non-transitory computer readable medium having stored thereon sequences of instruction for organizing media across a plurality of websites including instructions that will cause at least one processor to:
receive a set of authentication credentials, each member of the set of authentication credentials corresponding to a respective website of the plurality of websites;
execute a plurality of API calls, each API call of the plurality of API calls corresponding to a respective website of the plurality of websites, at least one API call of the plurality of API calls using a member of the set of authentication credentials;
receive a set of media information from at least one of the plurality of websites, each member of the set of media information corresponding to a respective piece of media of a plurality of pieces of media; and
store a plurality of point representations within the memory, each of the plurality of point representations corresponding to, and associated with, a respective piece of media of the plurality of pieces of media.

19. The computer readable medium according to claim 18, wherein the instructions will further instruct the at least one processor to:
receive a target date via an interface;
determine at least one owner identifier associated with media information dated within a range of the target date;
present, via the interface, a representation of at least one owner corresponding to the at least one owner identifier;
receive at least one selected owner selected via the interface;
present, via the interface, at least one piece of media of the plurality of pieces of media, the at least one piece of media being associated with an owner identifier corresponding to the at least one selected owner;
receive at least one selected piece of media selected via the interface; and
store at least one event representation within the memory, the event representation corresponding to, and associated with, the target date, the at least one selected owner, and the at least one selected piece of media.

20. The computer readable medium according claim 18, wherein the instructions will further instruct the at least one processor to:
identify at least one cluster of media information dated within a range of a central date; and
present, via the interface, a representation of the at least one cluster.
